(19) United States
(12) Patent Application Publication
(10) Pub. No.: US 2024/0168436 A1
(43) Pub. Date: May 23, 2024

(54) INFORMATION PROCESSING APPARATUS, INFORMATION PROCESSING METHOD, AND RECORDING MEDIUM

(71) Applicant: SONY GROUP CORPORATION, TOKYO (JP)

(72) Inventor: MASATO AKAO, TOKYO (JP)

(21) Appl. No.: 18/550,983

(22) PCT Filed: Feb. 2, 2022
(86) PCT No.: PCT/JP2022/003941

§ 371 Date: Sep. 18, 2023

(30) Foreign Application Priority Data
Mar. 29, 2021 (JP) 2021-056028

(51) Int. Cl. G03H 1/26; G03H 1/22

(52) U.S. Cl. CPC G03H 1/26; G03H 1/2286; G03H 2001/2615; G03H 2226/02; G03H 2240/13

(57) ABSTRACT

An information processing apparatus includes a detection unit and a change unit. The detection unit detects an overlap of a plurality of display areas each corresponding to an object beam of an object on a display surface of a display medium that displays hologram data. The change unit changes at least one of an amplitude and a phase of at least one of a plurality of the objects corresponding to the plurality of display areas overlapped so as to achieve the display areas different from a case where the display areas overlap each other on the display surface.

### FIELD

The present disclosure relates to an information processing apparatus, an information processing method, and a recording medium.

### BACKGROUND

A hologram display device calculates a hologram by performing a hidden surface removal process on a three-dimensional object to be reproduced and displayed, and irradiates the hologram with a reference wave to reproduce the three-dimensional object. Patent Literature 1 discloses a hologram generating device that generates hologram data (interference fringe) from an integrated object beam complex amplitude distribution and reference beam data. The integrated object beam complex amplitude distribution is obtained by integrating first-order complex amplitude distributions corresponding to a plurality of cameras.

### CITATION LIST

### Patent Literature

Patent Literature 1: JP 2013-54068 A

### SUMMARY

### Technical Problem

In a hologram display device, the number of pixels, a pixel pitch, gradation, display luminance, and the like are restricted by a display medium, and it is difficult to reproduce arbitrary object beam with high accuracy. Therefore, in a conventional hologram display device, it has been difficult to reproduce three-dimensional object beam of a plurality of objects with high image quality.

Therefore, the present disclosure proposes an information processing apparatus, an information processing method, and a recording medium capable of reproducing object beam of a plurality of objects on a display medium with high image quality.

### Solution to Problem

In order to solve the above problem, an information processing apparatus according to one embodiment of the present disclosure includes: a detection unit configured to detect an overlap of a plurality of display areas each corresponding to an object beam of an object on a display surface of a display medium that displays hologram data; and a change unit configured to change at least one of an amplitude and a phase of at least one of a plurality of the objects corresponding to the plurality of display areas overlapped when the plurality of display areas overlap each other, one of the amplitude and the phase being changed so as to achieve the display areas different from a case where the display areas overlap each other on the display surface.

Moreover, an information processing method according to one embodiment of the present disclosure causing a computer to implement: detecting an overlap of a plurality of display areas each corresponding to an object beam of an object on a display surface of a display medium that displays hologram data; and changing at least one of an amplitude and a phase of at least one of a plurality of the objects corresponding to the plurality of display areas overlapped when the plurality of display areas overlap each other, one of the amplitude and the phase being changed so as to achieve the display areas different from a case where the display areas overlap each other on the display surface.

Moreover, a computer-readable recording medium according to one embodiment of the present disclosure storing an information processing program causing a computer to implement: detecting an overlap of a plurality of display areas each corresponding to an object beam of an object on a display surface of a display medium that displays hologram data; and changing at least one of an amplitude and a phase of at least one of a plurality of the objects corresponding to the plurality of display areas overlapped when the plurality of display areas overlap each other, one of the amplitude and the phase being changed so as to achieve the display areas different from a case where the display areas overlap each other on the display surface.

### BRIEF DESCRIPTION OF DRAWINGS

FIG. 1 is a diagram illustrating an outline of generation of a hologram according to an embodiment.

FIG. 2 is a diagram illustrating an example of a relationship between object beam and a display surface of the hologram according to the embodiment.

FIG. 3 is a diagram illustrating an example of a display area of the hologram according to the embodiment.

FIG. 4 is a diagram illustrating an example of a relationship between a plurality of object beams and a display surface of the hologram according to the embodiment.

FIG. 5 is a diagram illustrating a schematic configuration of an information processing system according to a first embodiment.

FIG. 6 is a diagram illustrating an example of a processing outline of an information processing apparatus according to the first embodiment.

FIG. 7 is a diagram illustrating a function outline of the information processing apparatus according to the first embodiment.

FIG. 8 is a diagram illustrating the function outline of the information processing apparatus according to the first embodiment.

FIG. 9 is a flowchart illustrating an example of a processing procedure executed by the information processing apparatus according to the first embodiment.

FIG. 10 is a flowchart illustrating an example of an object beam generation process in FIG. 9.

FIG. 11 is a flowchart illustrating an example of a spatial arrangement control process in FIG. 10.

FIG. 12 is a flowchart illustrating an example of a wavefront propagation calculation process in FIG. 9.

FIG. 13 is a flowchart illustrating an example of a complex amplitude calculation process in FIG. 12.

FIG. 14 is a diagram illustrating an example of phase modulation by optimization in FIG. 13.

FIG. 15 is a flowchart illustrating an example of an interference fringe generation process in FIG. 9.

FIG. 16 is a diagram illustrating an example of a function outline of an information processing apparatus according to a second embodiment.

FIG. 17 is a diagram illustrating an example of phase modulation by optimization in the information processing apparatus according to the second embodiment.

FIG. 18 is a diagram illustrating another example of the function outline of the information processing apparatus according to the second embodiment.

FIG. 19 is a flowchart illustrating an example of a spatial arrangement process according to the second embodiment.

FIG. 20 is a diagram illustrating an example of phase modulation by optimization in an information processing apparatus according to a third embodiment.

FIG. 21 is a flowchart illustrating an example of an object beam generation process according to the third embodiment.

FIG. 22 is a flowchart illustrating an example of a spatial arrangement control process according to the third embodiment.

FIG. 23 is a diagram illustrating an example of a processing outline of an information processing apparatus according to a fourth embodiment.

FIG. 24 is a diagram illustrating an example of a function outline of the information processing apparatus according to the fourth embodiment.

FIG. 25 is a diagram illustrating an example of phase modulation by optimization in the information processing apparatus according to the fourth embodiment.

FIG. 26 is a flowchart illustrating an example of a spatial arrangement process according to the fourth embodiment.

FIG. 27 is a diagram illustrating a multilayer process of an information processing apparatus according to a fifth embodiment.

FIG. 28 is a diagram illustrating an example of a hidden surface process of a display medium.

FIG. 29 is a diagram illustrating a schematic configuration of an information processing system according to the fifth embodiment.

FIG. 30 is a diagram illustrating an example of a wavefront propagation calculation process of the information processing apparatus according to the fifth embodiment.

FIG. 31 is a diagram illustrating an information processing apparatus according to a sixth embodiment.

FIG. 32 is a diagram illustrating an example of a wavefront propagation calculation process of the information processing apparatus according to the sixth embodiment.

FIG. 33 is a flowchart illustrating an example of a processing procedure of a preliminary process in FIG. 32.

FIG. 34 is a hardware configuration diagram illustrating an example of a computer that implements functions of the information processing apparatus.

### DESCRIPTION OF EMBODIMENTS

Hereinafter, embodiments of the present disclosure are described in detail below with reference to the drawings. In each of the following embodiments, the same parts are given the same reference signs to omit redundant description.

### Overview of Hologram

A hologram is a display medium that records an interference fringe formed by interfering object beam reflected from an object with reference beam having high coherency such as a laser beam. When a light beam having same amplitude and phase as those of the reference beam is applied to the hologram, the hologram reproduces the object beam by diffraction of light. A detailed principle of the hologram is described in, for example, JP 2013-54068.

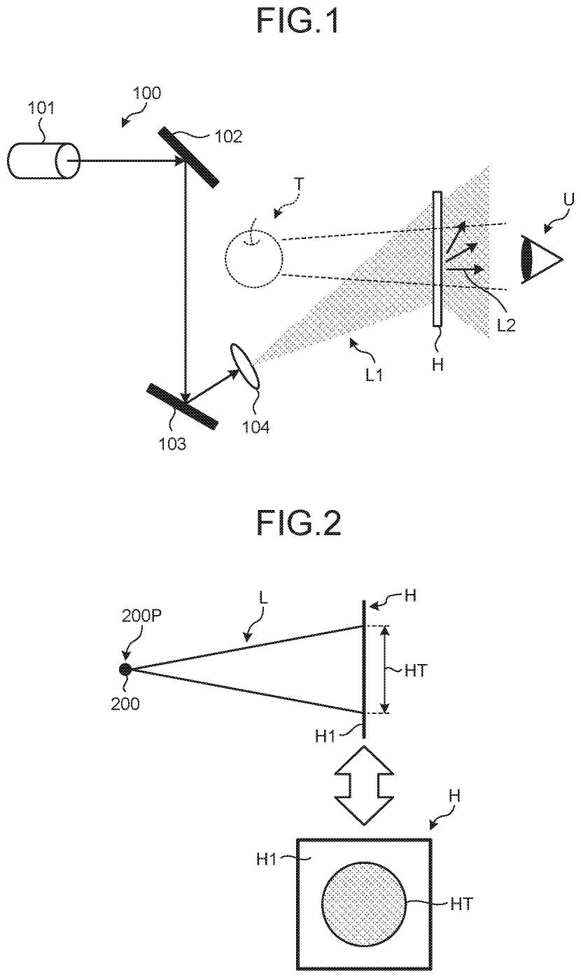

FIG. 1 is a diagram illustrating an outline of generation of the hologram according to the embodiment. In an example in FIG. 1, a hologram H (hologram data) makes it possible, as is known, to reproduce an image T of an object using a light beam L1 having a same amplitude and phase as the reference beam. The light beam L1 enters the hologram H through an optical system 100. The optical system 100 includes, for example, a laser light source 101, a collimator 102, a mirror 103, and a spatial filter 104. The hologram H reproduces object beam L2 of the object by being irradiated with the light beam L1 of the optical system 100. A user U recognizes the image T obtained by reproducing a stereoscopic object by visually recognizing the object beam L2 emitted from the hologram H.

FIG. 2 is a diagram illustrating an example of a relationship between the object beam and a display surface H1 of the hologram H according to the embodiment. As illustrated in an upper diagram of FIG. 2, one three-dimensional object position 200P is a position away from the display surface H1 of the hologram H for a predetermined distance. The display surface H1 of the hologram H includes a surface of the hologram H (hologram surface) on which light is projected. The display surface H1 indicates a range that the hologram H can be displayed. Object beam L traveling from the object position 200P toward the hologram H spreads according to a spatial frequency by wavefront propagation. A range of the object beam L projected on the display surface H1 of the hologram H is defined as a display area HT. In this case, as illustrated in the hologram H in a lower diagram of FIG. 2, the object beam L at the object position 200P is projected in a circular shape on the display surface H1. The display area HT is an area for displaying the object beam L on the display surface H1 of the hologram H, and is an area having a shape corresponding to the object 200. Note that the object beam L is light that spreads similarly for both an object larger than a point and one pixel.

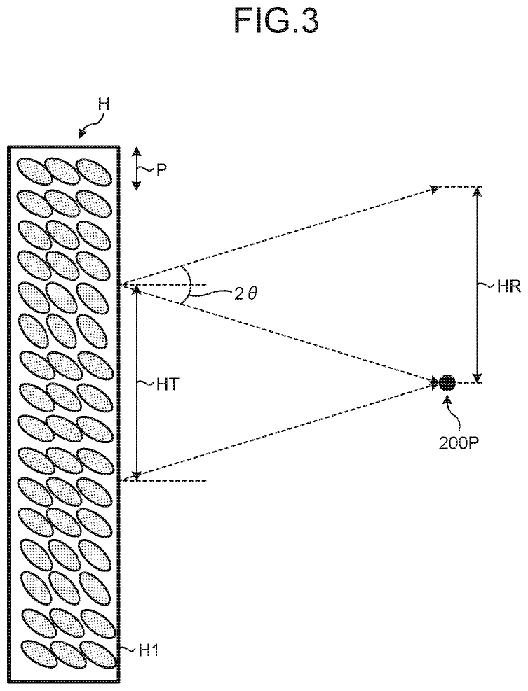

FIG. 3 is a diagram illustrating an example of the display area HT in the hologram H according to the embodiment. As illustrated in FIG. 3, the display area HT is a partial area on the display surface H1 of the hologram H. The display area HT is an area in which an area size, a position of the area on the display surface H1, and the like are different depending on an arrangement relation between the object position 200P and the hologram H. For example, when the display surface H1 has a pixel pitch P, a maximum diffraction angle θ can be calculated based on Expression (1) below.

2p*sin θ=λ Expression (1)

The hologram H can be considered to contribute to generation of the object beam L by condensing light in approximately an angular range HR. A range of the display area HT can be limited within a range of β*2θ by defining a prescribed parameter β. The parameter ⊕ is 0<β<=1. The parameter β can be defined differently depending on, for example, performance of the hologram H or data to be displayed.

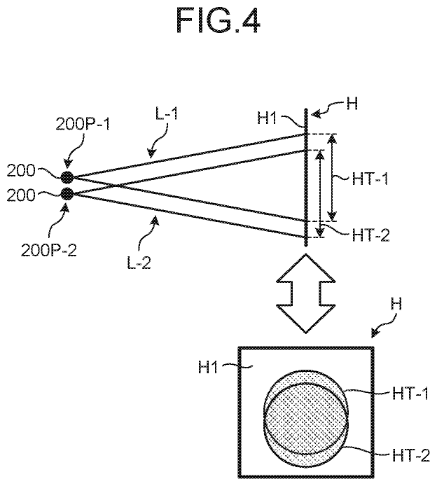

FIG. 4 is a diagram illustrating an example of a relationship between a plurality of object beams and the display surface H1 of the hologram H according to the embodiment. As illustrated in an upper diagram of FIG. 4, in two object beams L-1 and L-2 from two object positions 200P-1 and 200P-2, a display area HT-1 and a display area HT-2 may overlap on the display surface H1 even when distances from the object position 200P-1 and the object position 200P-2 to the hologram H are the same. In this case, in the hologram H illustrated in a lower diagram of FIG. 4, at least the display area HT-1 of the object beam L-1 at the object position 200P-1 and the display area HT-2 of the object beam L2 at the object position 200P-2 partially overlap on the display surface H1. Hereinafter, when the object position 200P-1 and the object position 200P-2 are not distinguished, the object position 200P-1 and the object position 200P-2 are referred to as the “object position 200P”.

When calculating wavefront data for the object beam L of the plurality of objects 200, a superposition principle is ideally established to simply add the wavefront data. However, when the wavefront data is converted into hologram data, an image quality tends to deteriorate as the number of object beams L superimposed is increased because the hologram H (display medium) that can be actually used has a performance limit. The performance limit includes, for example, finite spatial resolution, amplitude/phase quantization, and an accuracy limit of amplitude/phase display due to device characteristics. Therefore, the present disclosure provides an information processing apparatus and the like that can reproduce the object beams L of the plurality of objects 200 with high image quality on the display surface H1.

### First Embodiment

### [Schematic Configuration of Information Processing System]

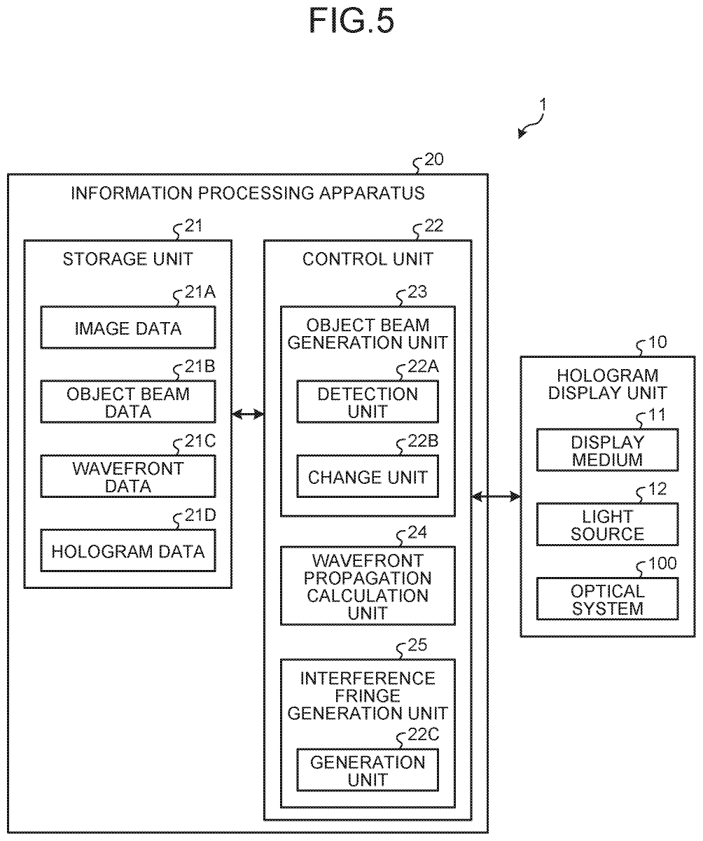

FIG. 5 is a diagram illustrating a schematic configuration of an information processing system 1 according to a first embodiment. The information processing system 1 illustrated in FIG. 5 is a system that reproduces a hologram H. The hologram H is, for example, hologram data generated based on image data. The image data includes, for example, image information and distance information. The image information includes, for example, information indicating a two-dimensional image obtained by imaging an object by a distance measuring camera. The image information includes a plurality of pieces of pixel information. The pixel information includes, for example, position information and intensity information. In the present disclosure, the hologram H is generated by performing a diffraction process based on the pixel information on each of a plurality of pixels in image data.

In the example illustrated in FIG. 5, the information processing system 1 includes a hologram display unit 10 and an information processing apparatus 20. The information processing apparatus 20 is electrically connected to the hologram display unit 10.

The hologram display unit 10 displays the hologram H based on the hologram data from the information processing apparatus 20. The hologram display unit 10 includes a display medium 11, a light source 12, and the optical system 100 described above.

The display medium 11 is a medium capable of recording the hologram data. The display medium 11 includes, for example, the hologram H and a spatial light modulator. The display medium 11 can include a function of outputting a complex amplitude distribution or the like of the display surface H1 indicated by the hologram data to a liquid crystal display or the like as a video signal. The light source 12 emits the light beam L1 corresponding to the reference beam under the control of the information processing apparatus 20. The light source 12 includes, for example, a laser light source 101. Light beam L1 emitted from the light source 12 is applied to the display medium 11 (hologram H) through the optical system 100.

### [Configuration Example of Information Processing Apparatus ]

The information processing apparatus 20 is, for example, a dedicated or general-purpose computer. The information processing apparatus 20 controls display on the hologram display unit 10. The information processing apparatus 20 has a function of generating the hologram data. The information processing apparatus 20 can include an interface and a communication device for enabling transmission and reception of data with an external electronic device.

The information processing apparatus 20 includes a storage unit 21 and a control unit 22. The control unit 22 is electrically connected to the hologram display unit 10 and the storage unit 21.

The storage unit 21 stores various types of data and programs. The storage unit 21 is realized by, for example, a semiconductor memory element such as a RAM or a flash memory, or a storage device such as a hard disk or an optical disk. The storage unit 21 stores various types of data such as image data 21A, object beam data 21B, wavefront data 21C, and hologram data 21D. The storage unit 21 is an example of a recording medium.

The image data 21A is data indicating an image that forms the basis of the hologram H. The image data 21A includes, for example, data indicating RGB and distance. The image data 21A includes data acquired from an external electronic device, server, or the like. The image data 21A may be, for example, data created from three-dimensional computer graphics.

The object beam data 21B is, for example, data indicating an object beam of a three-dimensional object obtained from the image data 21A. The object beam data 21B is, for example, data indicating light beams at different angles of the object for each of a plurality of layers. The layer indicates, for example, an arrangement relation of a plurality of objects 200 having different distances from the display surface H1 of the hologram H. The wavefront of the hologram H is propagated in the depth direction from a back layer to a front layer toward the display surface H1. In the present embodiment, a case where the object beam data 21B has a layer structure will be described, but the present disclosure is not limited thereto. The object beam data 21B may have another structure such as a point filling or polygon structure.

The wavefront data 21C is data indicating a complex amplitude (amplitude, phase) in the display medium 11. The wavefront data 21C is, for example, data obtained by calculating wavefront propagation to the display surface H1 for each layer.

The hologram data 21D is, for example, data obtained by calculating an interference fringe of the object beam and the reference beam on the display surface H1. The hologram data 21D includes a plurality of pieces of position data corresponding to a plurality of pixels configuring a hologram creation surface and at least one of phase data and amplitude data corresponding to the position data.

The control unit 22 controls the information processing apparatus 20. The control unit 22 includes processing units such as an object beam generation unit 23, a wavefront propagation calculation unit 24, and an interference fringe generation unit 25. The object beam generation unit 23 includes functional units such as a detection unit 22A and a change unit 22B. The interference fringe generation unit 25 includes a functional unit of a generation unit 22C.

In the present embodiment, each of the processing units of the control unit 22, i.e., the object beam generation unit 23, the wavefront propagation calculation unit 24, and of the interference fringe generation unit 25, is realized by, for example, a central processing unit (CPU) or a micro control unit (MCU) executing a program stored in the information processing apparatus 20 using a random access memory (RAM) as a work area. Note that each of the processing units may be realized by an integrated circuit such as an application specific integrated circuit (ASIC) or a field programmable gate array (FPGA) .

The object beam generation unit 23 generates the object beam data 21B indicating the object beam based on the image data 21A. For example, the object beam generation unit 23 acquires light beam information of different angles obtained from the object in the plurality of pieces of image data 21A to generate the object beam data 21B. The detection unit 22A of the object beam generation unit 23 detects an overlap of a plurality of display areas HT corresponding to the object beams L of the plurality of objects 200 on the display surface H1 of the display medium 11 that displays the hologram data 21D. For example, the detection unit 22A calculates the display areas HT of the objects 200 based on the object beam data 21B to detect the overlap of the display areas HT. The detection unit 22A stores, in the storage unit 21, information indicating the overlap detected.

When the plurality of display areas HT overlaps each other, the change unit 22B changes at least one of the amplitude and the phase of at least one object 200 among a plurality of overlapping objects 200. When the plurality of display areas HT overlaps each other, the change unit 22B changes at least one of the amplitude and the phase of the object 200 so that an overlapping display area HT is arranged to eliminate the overlap with another display area HT. For example, the change unit 22B determines the object 200 that can be moved based on the arrangement relation of the overlapping display areas HT on the display surface H1, and changes the position of the object 200 determined.

The wavefront propagation calculation unit 24 calculates the wavefront propagation based on the amplitude, the phase, and the like of the object beam data 21B. The wavefront propagation calculation unit 24 calculates the wavefront propagation by using, for example, a calculation method such as the Rayleigh-Sommerfeld diffraction formula, an angle spectrum method, Fresnel diffraction, or Fraunhofer diffraction. The wavefront propagation calculation unit 24 stores, in the storage unit 21, the wavefront data 21C indicating a calculation result.

The interference fringe generation unit 25 calculates, based on the wavefront data 21C, the interference fringe between the object beam and the reference beam represented by the complex amplitude of the display surface H1, and generates the hologram data 21D. For example, the interference fringe generation unit 25 generates the hologram data 21D to be displayed on the display medium 11 based on the interference fringe calculated. The interference fringe generation unit 25 stores, in the storage unit 21, the hologram data 21D generated.

The generation unit 22C of the interference fringe generation unit 25 generates the hologram data 21D having at least one of the amplitude and the phase of the object 200 changed by the change unit 22B. For example, the generation unit 22C re-expresses the complex amplitude only with the amplitude or the phase in order to display the complex amplitude with a spatial light modulator (SLM). When the SLM is a two-plate type, the generation unit 22C may perform simultaneous modulation of the amplitude and phase.

The functional configuration example of the information processing apparatus 20 according to the first embodiment has been described above. Note that the functional configuration described above with reference to FIG. 5 is merely an example, and the functional configuration of the information processing apparatus 20 according to the present embodiment is not limited thereto. The functional configuration of the information processing apparatus 20 according to the present embodiment can be flexibly modified according to specifications and operations.

In the present embodiment, a case where the object beam generation unit 23 of the information processing apparatus 20 includes the detection unit 22A and the change unit 22B will be described, but the present invention is not limited thereto. For example, the detection unit 22A and the change unit 22B may be implemented by the wavefront propagation calculation unit 24 or may be implemented as an independent processing unit. In the information processing apparatus 20, a case where the interference fringe generation unit 25 includes the generation unit 22C will be described, but the present invention is not limited thereto. For example, the generation unit 22C may be realized as an independent processing unit.

### [Example of Function Outline of Information Processing Apparatus According to First Embodiment]

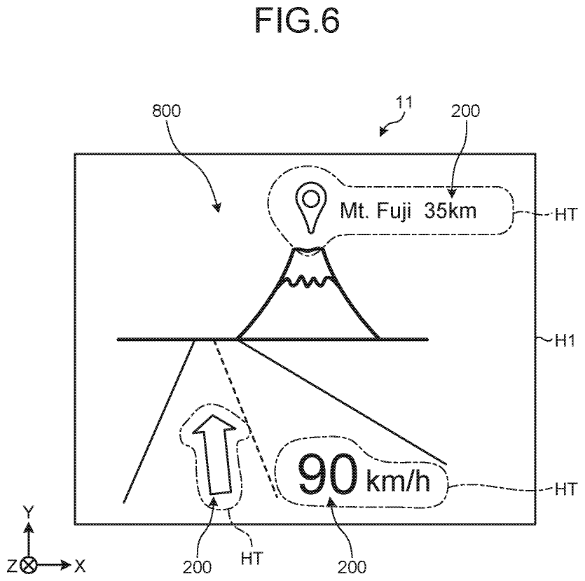

FIG. 6 is a diagram illustrating an example of a processing outline of the information processing apparatus 20 according to the first embodiment. In an XYZ orthogonal coordinate system illustrated in FIG. 6, one direction in a horizontal plane is an X-axis direction, a direction orthogonal to the X-axis direction in the horizontal plane is a Y-axis direction, and a direction orthogonal to both the X-axis direction and the Y-axis direction is a Z-axis direction. An XY plane including the X axis and the Y axis is a plane orthogonal to the horizontal plane. The Z-axis direction orthogonal to the XY plane is a line-of-sight direction of the user.

As illustrated in FIG. 6, the information processing apparatus 20 has an on-screen display (OSD) function of displaying the object 200 on an on-vehicle head up display having optical transparency. The information processing apparatus 20 allows the user to visually recognize the object 200 and a foreground 800 through the display medium 11 by displaying the object 200 on the display medium 11 having transparency.

In the example illustrated in FIG. 6, the information processing apparatus 20 displays, on the display medium 11, a plurality of objects 200 related to navigation. The plurality of objects 200 include, for example, objects such as a vehicle speed, a route (arrow), and a destination. In this case, the line-of-sight direction of the user viewing the display medium 11 is the Z-axis direction, and may be determined in advance with reference to a position of a user's viewpoint, or may be detected by an active sensor or the like. The information processing apparatus 20 displays the object 200 indicating the speed at a fixed position on the display surface H1. The information processing apparatus 20 may change display positions of the objects 200 such as the route and the destination on the display surface H1 based on a positional relation with the foreground 800.

For example, on the display surface H1, when the display positions of the object 200 indicating the speed and the object 200 indicating the route are apart from each other, their display areas HT do not overlap each other. However, when the display positions are close to each other, the display areas HT overlap each other. The display areas HT have shapes corresponding to the outline of characters, arrows, symbols, and the like. When the display areas HT are overlapped, the information processing system 1 may reduce the visibility of the plurality of objects 200. Therefore, the information processing apparatus 20 provides a function of comprehensively optimizing the image quality, a visual effect, and the visibility by controlling an arrangement of the plurality of objects 200.

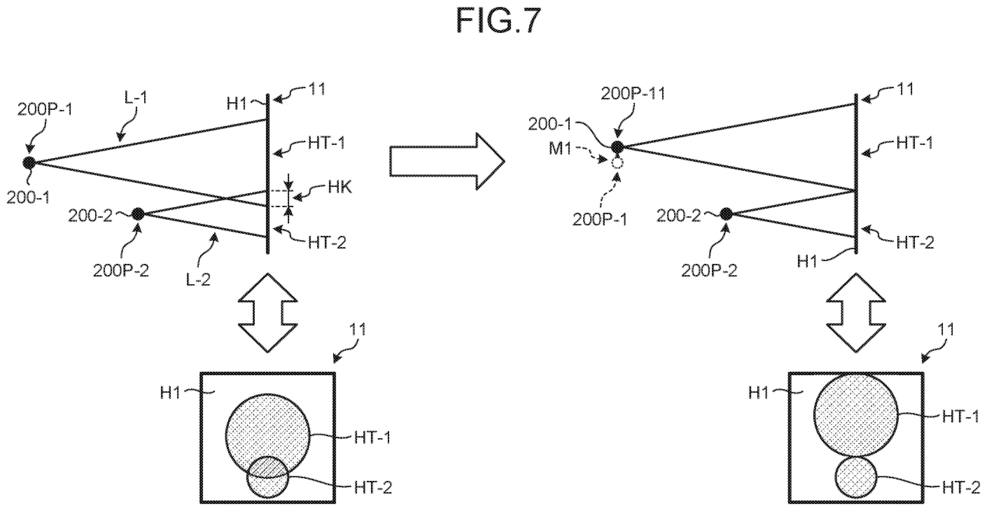

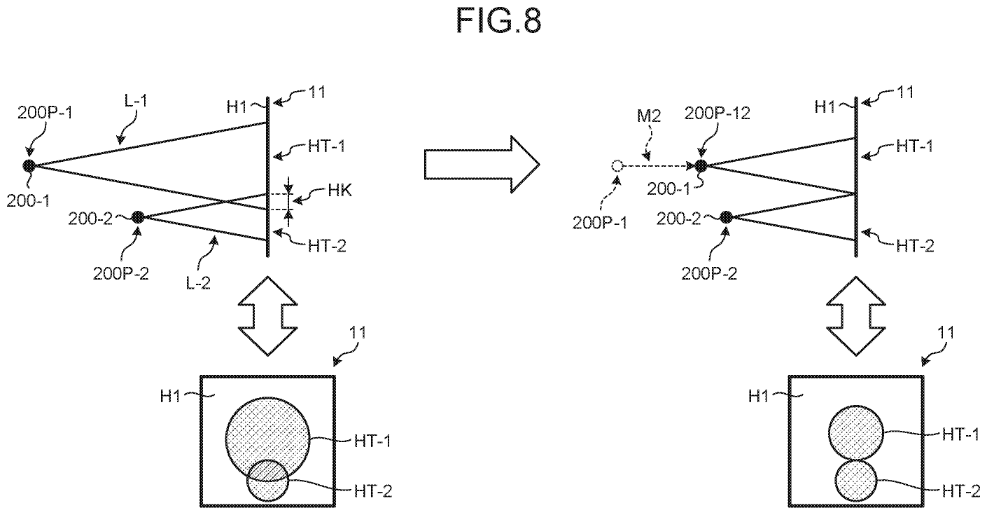

FIGS. 7 and 8 are diagrams illustrating the function outline of the information processing apparatus 20 according to the first embodiment. As illustrated in a left diagram of FIG. 7, two object positions 200P-1 and 200P-2 are arranged at different distances from the display medium 11. An object 200-1 at the object position 200P-1 has a larger shape than an object 200-2. The object beam L-1 and the object beam L-2 from the two object positions 200P-1 and 200P-2 partially overlap each other in the display area HT-1 and the display area HT-2 on the display surface H1 of the display medium 11. When the information processing apparatus 20 detects an overlap HK between the display area HT-1 and the display area HT-2, the information processing apparatus 20 changes the object position 200P of the object 200 so as to achieve an arrangement that emits the overlap HK between the display areas HT. Elimination of the overlap HK of the display areas HT does not require, for example, completely eliminating the overlap of the display areas HT, and includes reduction of an overlapping area, ratio, or the like of the display areas HT.

For example, the information processing apparatus 20 changes the arrangement of the objects 200 so that the overlapping ratio of the display areas HT becomes equal to or less than a reference value. The reference value may be a fixed value, or may be set according to a pattern of the object 200, a display position on the display surface H1, or the like. When colors and brightness of the plurality of objects 200 are close to each other, the information processing apparatus 20 may increase the reference value to allow the overlap HK of the display areas HT. When a display position of one of overlapping objects 200 is close to an edge of the display surface H1, the information processing apparatus 20 may increase the reference value to allow the overlap HK of the display areas HT.

In the example illustrated in a right diagram of FIG. 7, since the object 200-2 is close to the edge of the display surface H1, the information processing apparatus 20 moves the object 200-1 in a transfer direction M1 that eliminates the overlap HK of the display areas HT. The transfer direction M1 is a horizontal direction on the display surface H1, and is a direction from the object position 200P-1 to an object position 200P-11. The information processing apparatus 20 causes the display medium 11 to display the hologram data 21D of the changed object 200-1. Accordingly, in the display medium 11, the display area HT-1 of the object 200-1 and the display area HT-2 of the object 200-2 do not overlap each other.

A left diagram of FIG. 8 is the same as the left diagram of FIG. 7. In other words, as illustrated in the left diagram of FIG. 8, the object beam L-1 and the object beam L-2 from the two object positions 200P-1 and 200P-2 partially overlap in the display area HT-1 and the display area HT-2 on the display surface H1 of the display medium 11. When the information processing apparatus 20 detects an overlap HK between the display area HT-1 and the display area HT-2, the information processing apparatus 20 changes the object position 200P of the object 200 so as to achieve an arrangement that emits the overlap HK between the display areas HT.

In the example illustrated in a right diagram of FIG. 8, the object 200-2 is close to the edge of the display surface H1, and a movable space of the object 200-1 is also limited in the information processing apparatus 20. The display area HT decreases as the object 200 approaches the display surface H1. For this reason, the information processing apparatus 20 moves the object 200-1 in a transfer direction M2 from the object position 200P-1 toward the display surface H1 in order to eliminate the overlap HK of the display areas HT. The information processing apparatus 20 moves, on the display surface HT, the object 200-1 to the object position 200P-11 having a size at which the display area HT-1 of the object 200-1 is in contact with the display area HT-2 of the object 200-2. The information processing apparatus 20 causes the display medium 11 to display the hologram data 21D of the changed object 200-1. Accordingly, in the display medium 11, the display area HT-1 of the object 200-1 and the display area HT-2 of the object 200-2 do not overlap each other.

In the present embodiment, a case where the information processing apparatus 20 moves the object 200 in the transfer direction M1 or the transfer direction M2 when detecting the overlap HK between the display area HT-1 and the display area HT-2 will be described, but the present invention is not limited thereto. The information processing apparatus 20 may move the object 200 in a direction in which the transfer direction M1 and the transfer direction M2 are combined.

### [Example of Processing Procedure of Information Processing Apparatus According to First Embodiment]

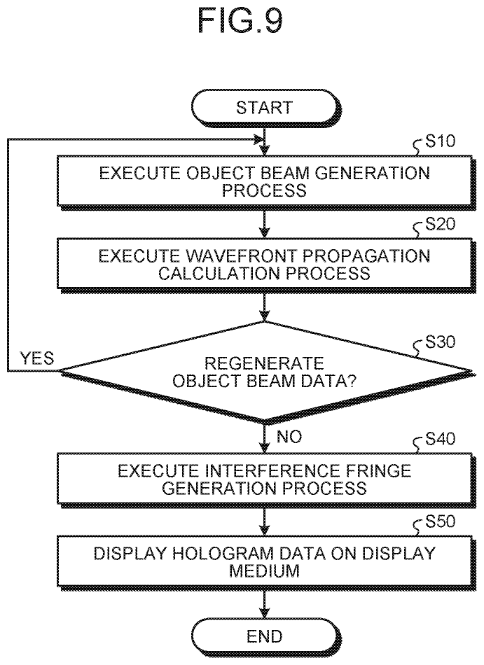

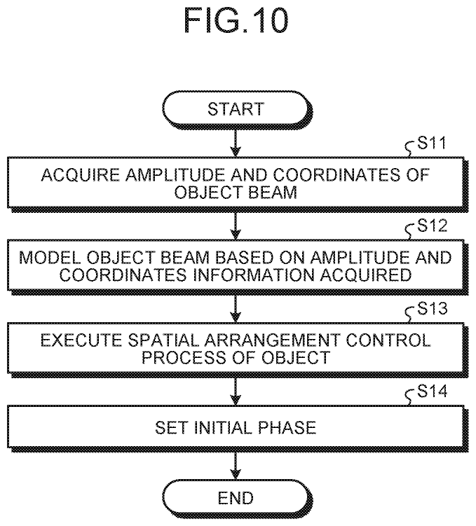

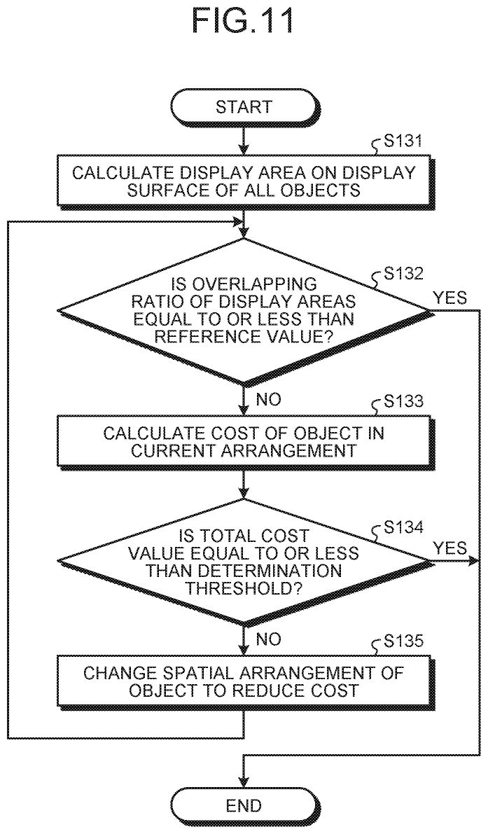

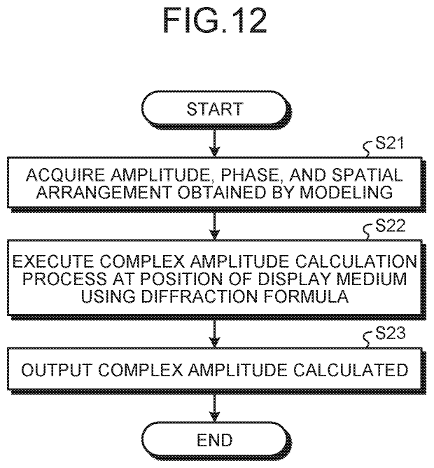

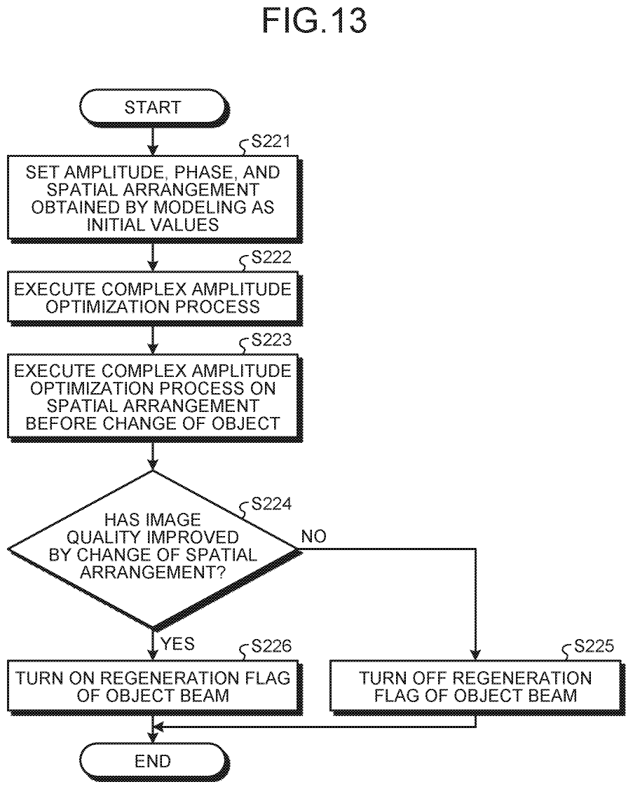

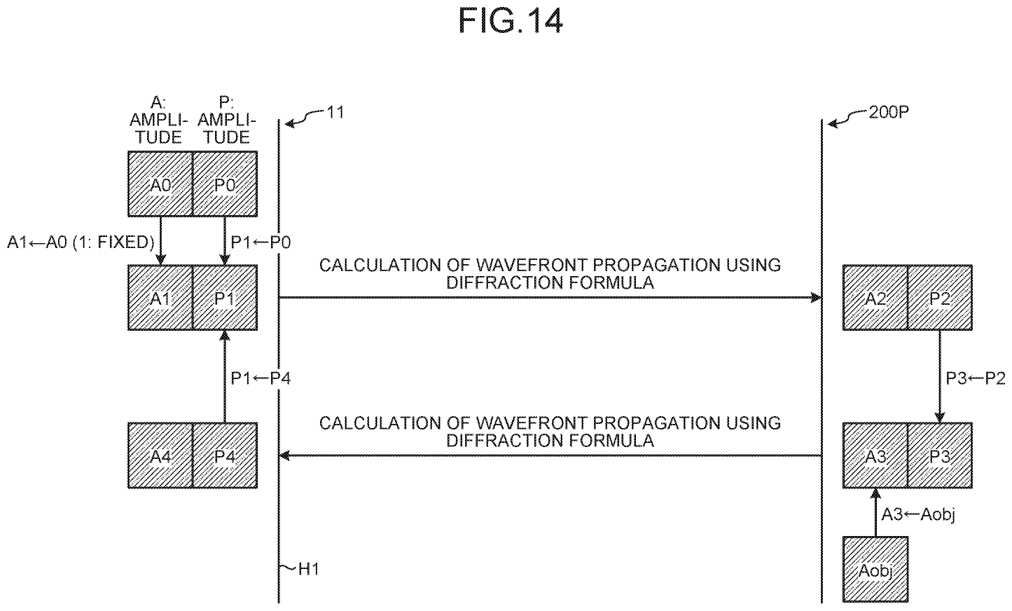

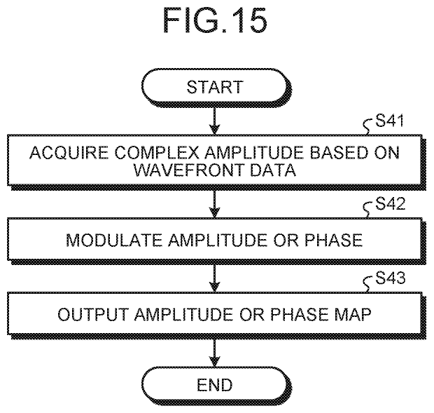

FIG. 9 is a flowchart illustrating an example of processing procedure executed by the information processing apparatus 20 according to the first embodiment. FIG. 10 is a flowchart illustrating an example of an object beam generation process in FIG. 9. FIG. 11 is a flowchart illustrating an example of a spatial arrangement control process in FIG. 10. FIG. 12 is a flowchart illustrating an example of a wavefront propagation calculation process in FIG. 9. FIG. 13 is a flowchart illustrating an example of a complex amplitude calculation process in FIG. 12. FIG. 14 is a diagram illustrating an example of phase modulation by optimization in FIG. 13. FIG. 15 is a flowchart illustrating an example of an interference fringe generation process in FIG. 9. The processing procedure in FIGS. 9 to 13 and FIG. 15 are implemented by the control unit 22 of the information processing apparatus 20 executing a program.

As illustrated in FIG. 9, the control unit 22 of the information processing apparatus 20 executes the object beam generation process (Step S10). The object beam generation process includes, for example, a process of generating the object beam data 21B based on the image data 21A.

### [Object Beam Generation Process]

For example, when the object beam generation process illustrated in FIG. 10 is executed, the control unit 22 acquires an amplitude and coordinates of the object beam (Step S11). For example, the control unit 22 acquires the amplitude and spatial coordinates of the object beam L based on RGB and distance of the image data 21A. For example, the control unit 22 may acquire the amplitude and spatial coordinates of the object beam L using data captured by an RGB-D camera capable of capturing a three-dimensional point group. When the process in Step S11 is completed, the control unit 22 advances the process to Step S12.

The control unit 22 models the object beam L based on amplitude and coordinates information acquired (Step S12). For example, the control unit 22 generates an image corresponding to a layer by executing a process of converting the light beam information so as to match specifications of a hologram to be generated, and generates the object beam data 21B based on the image. For example, the control unit 22 may use a known method for the process of converting the light beam information. Examples of the known technique include integral photography. After storing the object beam data 21B in the storage unit 21, the control unit 22 advances the process to Step S13.

The control unit 22 executes the spatial arrangement control process of the objects 200 (Step S13). The spatial arrangement control process includes, for example, a process of changing a spatial arrangement of the objects 200 based on the overlap HK of the display areas HT of the objects 200 on the display surface H1. The spatial arrangement means, for example, the arrangement of the objects 200 in a display space in which the objects 200 are displayed. The spatial arrangement control includes, for example, control related to a change of arrangement of the objects 200 in the display space.

### [Spatial Arrangement Control Process]

For example, when the spatial arrangement control process illustrated in FIG. 11 is executed, the control unit 22 calculates the display areas HT of all the objects 200 on the display surface H1 (Step S131). For example, as described above, the control unit 22 calculates each the display areas HT based on information such as specifications of the display medium 11, an arrangement relation between the object position 200P of the object 200 and the display medium 11. When the process in Step S131 is completed, the control unit 22 advances the process to Step S132.

The control unit 22 determines whether or not the overlapping ratio of the display areas HT is equal to or less than the reference value (Step S132). For example, the control unit 22 calculates a ratio of the overlap HK of the display areas HT on the display surface H1, and determines that the overlapping ratio of the display areas HT is equal to or less than the reference value when the calculated ratio is equal to or less than the reference value described above.

When the overlapping ratio of the display areas HT is determined to be equal to or less than the reference value (Yes in Step S132), the control unit 22 ends the spatial arrangement control process illustrated in FIG. 11, since there is no need to change the arrangement of the objects 200, and returns the process to Step S13 illustrated in FIG. 10.

When the overlapping ratio of the display areas HT is determined to be greater than the reference value (No in Step S132), the control unit 22 advances the process to Step S133.

The control unit 22 calculates cost of the objects 200 in the current arrangement (Step S133). For example, the control unit 22 uses an evaluation function to obtain the cost of each the objects 200. The evaluation function obtains information on the foreground 800 of the display medium 11 to obtain the cost of the object 200. For example, the control unit 22 acquires the image information obtained by capturing the foreground 800 and foreground information based on the current position to obtain the cost of the object 200 based on these pieces of information. The evaluation function decreases the cost as the display position of the object 200 in the XY plane illustrated in FIG. 6 is closer to actual foreground 800. The evaluation function decreases the cost as the display position of the object 200 in the Z-axis direction illustrated in FIG. 6 is closer to the actual foreground 800. Since an influence of displacement of the display position is smaller in the Z-axis direction than in the XY plane, the evaluation function individually evaluates the XY plane and the Z-axis direction. The evaluation function decreases the cost as the overlap HK of the display areas HT of the objects 200 is smaller. The evaluation function calculates a total cost value of the objects 200 in the XY plane, the cost of the objects 200 in the Z-axis direction, and the cost of the overlap HK of the display areas HT. After storing, in the storage unit 21, the cost of the objects 200 in the current arrangement calculated using the evaluation function, the control unit 22 advances the process to Step S134.

The control unit 22 determines whether or not the total cost value is equal to or less than a determination threshold (Step S134). For example, the control unit 22 compares the total cost value calculated in Step S133 with the determination threshold, and determines that the total cost value is equal to or less than the determination threshold when the total value is equal to or less than the determination threshold. The determination threshold is, for example, a threshold set in advance for comprehensively determining the image quality, visual effect, and visibility. When the control unit 22 determines that the total cost value is greater than the determination value, i.e., when it is determined that the arrangement of the objects 200 needs to be changed (No in Step S134), the control unit 22 advances the process to Step S135.

The control unit 22 changes the spatial arrangement of the objects 200 so as to reduce the cost (Step S135). For example, the control unit 22 changes the object positions 200P of the objects 200 so as to minimize the total cost value. For example, the control unit 22 identifies an object 200 that causes a high cost, changes the object position 200P of this object 200, or changes the object position 200P of another object 200 around the object 200. When the process in Step S135 is completed, the control unit 22 returns the process to Step S132 described above and continues the process. In other words, the control unit 22 executes processing on the objects 200 whose spatial arrangement has been changed.

On the other hand, when the total cost value is equal to or less than the determination value, i.e., when it is determined that there is no need to change the arrangement of the objects 200 (Yes in Step S134), the control unit 22 ends the spatial arrangement control process illustrated in FIG. 11 and returns the process to Step S13 illustrated in FIG. 10.

Returning to FIG. 10, when the process in Step S13 is completed, the control unit 22 sets an initial phase (Step S14). For example, the control unit 22 uniformly changes the phase according to the XY coordinates with respect to a pixel value of the object beam data 21B, thereby acquiring complex amplitude of the amplitude and the phase of the object beam L for each pixel. The control unit 22 sets the phase acquired as the initial phase in the object beam data 21B. When the process in Step S14 is completed, the control unit 22 ends the object beam generation process illustrated in FIG. 10 and returns the process to Step S10 illustrated in FIG. 9.

Returning to FIG. 9, when the process in Step S10 is completed, the control unit 22 advances the process to Step S20. The control unit 22 executes the wavefront propagation calculation process (Step S20). The wavefront propagation calculation process includes, for example, a process of calculating wavefront propagation based on the object beam data 21B.

### [Wavefront Propagation Calculation Process]

For example, when the wavefront propagation calculation process illustrated in FIG. 12 is executed, the control unit 22 acquires the amplitude, phase, and spatial arrangement obtained by modeling (Step S21). For example, the control unit 22 acquires information on amplitude, phase, and spatial arrangement of each layer image based on the object beam data 21B. When the process in Step S21 is completed, the control unit 22 advances the process to Step S22.

The control unit 22 executes the complex amplitude calculation process at the position of the display medium 11 by using a diffraction formula (Step S22). The complex amplitude calculation process includes, for example, a process of calculating the complex amplitude based on the amplitude, phase, and spatial arrangement obtained by modeling. The diffraction formula includes, for example, the Rayleigh-Sommerfeld diffraction formula, a high-speed calculation method, and an approximate calculation method. For the calculation of the complex amplitude at the position of the display medium 11, an angular spectrum method, Fresnel diffraction, Fraunhofer diffraction, or the like may be used.

### [Complex Amplitude Calculation Process]

For example, when the complex amplitude calculation process illustrated in FIG. 13 is executed, the control unit 22 sets the amplitude, phase, and spatial arrangement obtained by modeling as initial values (Step S221). For example, the control unit 22 sets the amplitude, phase, and spatial arrangement acquired in Step S21 as the initial values. When the process in Step S221 is completed, the control unit 22 advances the process to Step S222.

The control unit 22 executes the complex amplitude optimization process (Step S222). For example, the complex amplitude optimization process includes a process of calculating the complex amplitude at the position of the display medium 11 by iterative calculation. As an iterative calculation method, for example, the known Gerchberg-Saxton algorithm (GS algorithm) and Wirtinger Holography can be used.

As illustrated in FIG. 14, the control unit 22 repeatedly performs wavefront propagation calculation using the diffraction formula between the display surface H1 of the display medium 11 and the object position 200P of the object 200, and applies a constraint condition between the display surface H1 and the object position 200P. For example, on the display surface H1, an amplitude A1 is fixed to an amplitude A0, which is an initial value with a fixed value of 1. At the object position 200P, an amplitude A3 is fixed to an amplitude Aobj of an optimization target obtained from the image data 21A. The control unit 22 calculates an amplitude A2 and a phase P2 at the object position 200P by the wavefront propagation calculation of the amplitude A1 and a phase P1 of the display surface H1. The control unit 22 sets the amplitude Aobj to the amplitude A3 and the phase P2 to the phase P3, and calculates an amplitude A4 and a phase P4 of the display surface H1 by the wavefront propagation calculation of the amplitude A3 and the phase P3 at the object position 200P. The control unit 22 sets the phase P4 to the phase P1 and calculates the amplitude A2 and the phase P2 at the object position 200P by the wavefront propagation calculation of the amplitude A1 and the phase P1 of the display surface H1. By repeating the wavefront propagation calculation, the control unit 22 brings the amplitude A2 close to the amplitude Aobj and brings the amplitude A4 close to a constant value. The control unit 22 stores, in the storage unit 21, a result of the complex amplitude optimization process.

In FIG. 14, one object position 200P is used to simplify the description, but when there is a plurality of object positions 200P, similar calculation may be performed for each of the plurality of object positions 200P. Furthermore, in the present embodiment, a case where the control unit 22 uses the GS algorithm as the iterative method will be described, but Wirtinger Holography may be used as the iterative method. When Wirtinger Holography is used as the iterative method, the control unit 22 causes the amplitude A2 to approach the amplitude Aobj by repeating the wavefront propagation calculation.

Returning to FIG. 13, when the process in Step S222 is completed, an optimization process for the spatial arrangement before changing the object 200 is executed (Step S223). For example, the control unit 22 sets the amplitude, the phase, and the spatial arrangement obtained by modeling to the values before the change, and executes the optimization process in Step S222. After storing, in the storage unit 21, a result of the complex amplitude optimization process before the change, the control unit 22 advances the process to Step S224.

The control unit 22 determines whether the image quality has been improved by the change of the spatial arrangement (Step S224). For example, the control unit 22 makes a determination based on a result of whether the image quality of a reproduced image has been improved before and after the change of the spatial arrangement of the objects 200. The image quality is obtained by an image quality evaluation scale such as a signal-to-noise ratio (SNR). As the reproduction image, data obtained by simulation or capturing an image actually displayed in a plurality of focal lengths can be used. The control unit 22 obtains the image quality according to respective results of Steps S222 and S223, and determines that the image quality has been improved by the change of the spatial arrangement when an improvement range of image quality of the reproduced image is equal to or greater than a determination threshold. The determination threshold may be set as a value for determining whether or not it is necessary to change the spatial arrangement of the object 200.

When the control unit 22 determines that the image quality is not improved by the change of the spatial arrangement (No in Step S224), the process advances to Step S225. The control unit 22 turns off a regeneration flag of the object beam L (Step S225). The regeneration flag is a flag that is turned on when the spatial arrangement of the object 200 will be changed. When the process in Step S225 is completed, the control unit 22 ends the complex amplitude calculation process illustrated in FIG. 13 and returns the process to Step S22 illustrated in FIG. 12.

When the control unit 22 determines that the image quality has been improved by the change of the spatial arrangement (Yes in Step S224), the process advances to Step S226. The control unit 22 turns on the regeneration flag of the object beam L (Step S226). When the process in Step S226 is completed, the control unit 22 ends the complex amplitude calculation process illustrated in FIG. 13 and returns the process to Step S22 illustrated in FIG. 12.

Returning to FIG. 12, the control unit 22 outputs the calculated complex amplitude (Step S23). For example, the control unit 22 outputs wavefront data 21C indicating the calculated complex amplitude to the interference fringe generation unit 25. When the process in Step S23 is completed, the control unit 22 ends the processing procedure illustrated in FIG. 12 and returns the process to Step S20 illustrated in FIG. 9. The control unit 22 implements the wavefront propagation calculation unit 24 by executing the processing procedure illustrated in FIG. 12.

Returning to FIG. 9, when the process in Step S20 is completed, the control unit 22 advances the process to Step S30. The control unit 22 determines whether or not to regenerate the object beam data 21B (Step S30). For example, when the regeneration flag is on, the control unit 22 determines to regenerate the object beam data 21B. When it is determined to regenerate the object beam data 21B (Yes in Step S30), the control unit 22 returns the process to the already described process in Step S10 and continues the process. When it is determined not to regenerate the object beam data 21B (No in Step S30), the control unit 22 advances the process to Step S40.

The control unit 22 executes the interference fringe generation process (Step S40). The interference fringe generation process includes, for example, a process of re-expressing the complex amplitude only with the amplitude or the phase in order to display the complex amplitude on the display medium 11.

### [Interference Fringe Generation Process]

For example, when the interference fringe generation process illustrated in FIG. 15 is executed, the control unit 22 acquires the complex amplitude based on the wavefront data 21C (Step S41). For example, the control unit 22 acquires the complex amplitude for each object position 200P (layer) based on the wavefront data 21C. When the process in Step S41 is completed, the control unit 22 advances the process to Step S42.

The control unit 22 modulates the amplitude or the phase (Step S42). For example, the control unit 22 modulates the amplitude or the phase of the image using a phase modulation system such that the complex amplitude is expressed only by the amplitude or the phase in order to display the image on display medium 11. The phase modulation system includes, for example, a double phase method. When the GS algorithm is used, since the GS algorithm includes the phase modulation process, the control unit 22 needs to use only the phase while discarding the amplitude approaching the constant value. For example, the control unit 22 calculates the interference fringe between the object beam L indicated by the amplitude or the phase of the display surface H1 calculated for each image of the object position 200P and the reference beam, thereby calculating a hologram map. When the process in Step S42 is completed, the control unit 22 advances the process to Step S43.

The control unit 22 outputs an amplitude or phase map (Step S43). For example, the control unit 22 outputs, to the storage unit 21, the hologram data 21D indicating the hologram map calculated to store the hologram data in the storage unit 21. For example, the control unit 22 may output the hologram data 21D to the hologram display unit 10. When the process in Step S43 is completed, the control unit 22 ends the processing procedure illustrated in FIG. 15 and returns the process to Step S40 illustrated in FIG. 9. The control unit 22 implements the interference fringe generation unit 25 by executing the processing procedure illustrated in FIG. 15.

Returning to FIG. 9, when the process of Step S40 is completed, the control unit 22 displays the hologram data 21D on the display medium 11 (Step S50). For example, the control unit 22 outputs the hologram data 21D to the display medium 11 and emits the light beam L1 having the same amplitude and phase as the reference beam from the light source 12 to reproduce an image of the object 200. When the process in Step S50 is completed, the control unit 22 ends the processing procedure illustrated in FIG. 9.

In the processing procedure illustrated in FIG. 9, the case of determining whether or not to regenerate the object beam data 21B in Step S30 has been described, but the present invention is not limited thereto. For example, the processing procedure illustrated in FIG. 9 may be configured to include a determination process in the process of Step S20.

As described above, the information processing apparatus 20 according to the first embodiment can detect the overlap HK of the plurality of display areas HT corresponding to the plurality of objects 200 on the display surface H1. When the plurality of display areas HT overlaps each other, the information processing apparatus 20 changes at least one of the amplitude and the phase of at least one object 200 among the plurality of objects 200 corresponding to the overlapping display areas HT, so that the display areas HT are different from a case where the display areas HT overlap each other on the display surface H1. Accordingly, when the display areas HT overlap each other on the display surface H1, the information processing apparatus 20 can change the spatial arrangement of the objects 200. As a result, the information processing apparatus 20 can reproduce the object beams L of the plurality of objects 200 with high image quality on the display medium 11. Furthermore, the information processing apparatus 20 can maintain a stereoscopic effect without excessively increasing the depth of field of the plurality of objects 200.

When the plurality of display areas HT overlaps each other, the information processing apparatus 20 can change at least one of the amplitude and the phase of the objects 200 so as to achieve an arrangement that eliminates the overlap HK of the display area HT with another display area HT. Accordingly, the information processing apparatus 20 can suppress the plurality of object beams L from overlapping on the display surface H1. As a result, the information processing apparatus 20 can reproduce the object beams L of the plurality of objects 200 with further higher image quality on the display medium 11. Furthermore, the information processing apparatus 20 can more reliably maintain the stereoscopic effect without making the depth of field of the plurality of objects 200 too deep.

Note that the information processing apparatus 20 according to the first embodiment may be applied to or combined with the information processing apparatus 20 of another embodiment or modification.

### Second Embodiment

Next, an example of an information processing apparatus 20 according to a second embodiment will be described. In the first embodiment, when the plurality of display areas HT overlaps each other on the display surface H1 of the display medium 11, the object position of the object 200 is changed. In the second embodiment, a case where the display area HT is changed by another method will be described. An information processing system 1 according to the second embodiment has the same configuration as the information processing system 1 according to the first embodiment.

### [Example of Function Outline of Information Processing Apparatus According to Second Embodiment]

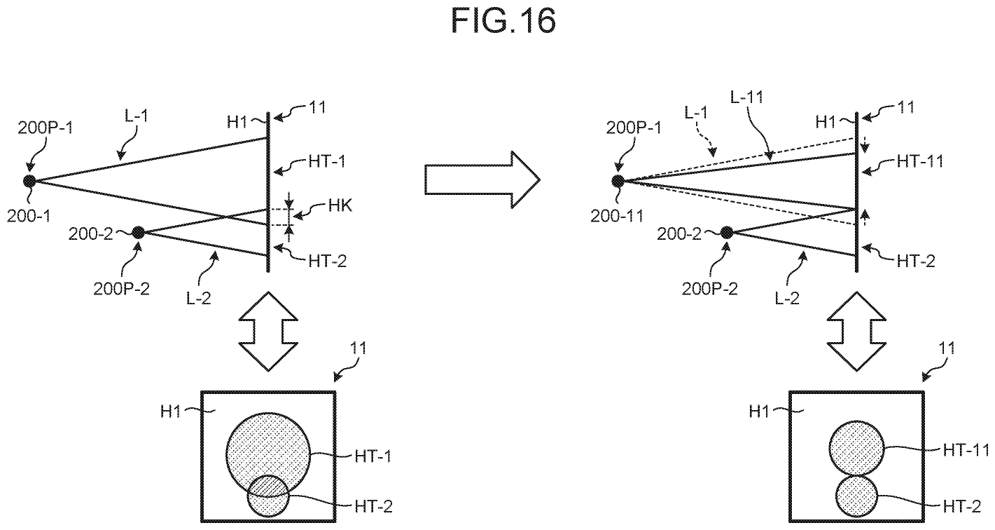

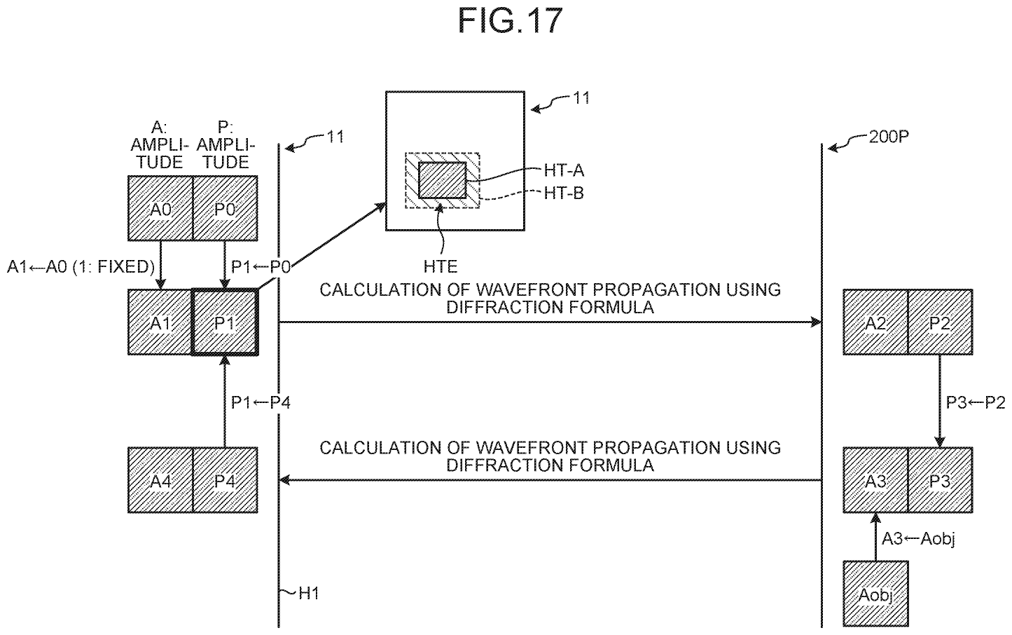

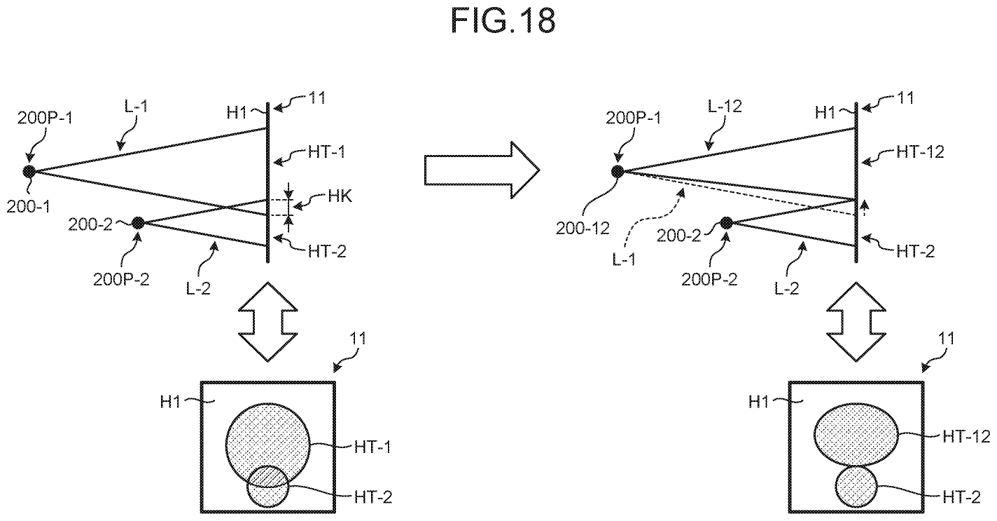

The change unit 22B of the information processing apparatus 20 provides a function of changing at least one of the amplitude and the phase of the object 200 so as to achieve at least one of a size and a shape that eliminates an overlap of the plurality of display areas HT when the plurality of display areas HT overlaps each other. FIG. 16 is a diagram illustrating an example of a function outline of the information processing apparatus 20 according to the second embodiment. FIG. 17 is a diagram illustrating an example of phase modulation by optimization in the information processing apparatus 20 according to the second embodiment. FIG. 18 is a diagram illustrating another example of the function outline of the information processing apparatus 20 according to the second embodiment.

A left diagram of FIG. 16 is the same as the left diagram of FIG. 7 described above. In other words, as illustrated in the left diagram of FIG. 16, the object beam L-1 and the object beam L-2 at the two object positions 200P-1 and 200P-2 partially overlap with respect to the display area HT-1 and the display area HT-2 on the display surface H1 of the display medium 11. When the overlap HK between the display area HT-1 and the display area HT-2 is detected, the information processing apparatus 20 changes a spread size of the object beam L-1 of the object 200-1 and the size of the display area HT-1 so as to achieve an arrangement that eliminates the overlap HK between the display areas HT.

In the example illustrated in a right diagram of FIG. 16, the object 200-2 is close to the edge of the display surface H1, and a movable space of the object 200-1 is also limited in the information processing apparatus 20. When the spread size of the object beam L-1 of the object 200-1 is reduced, the display area HT-1 is reduced. In order to eliminate the overlap HK in the display area HT-1, the information processing apparatus 20 changes the spread size of the object beam L-1 of the object 200-1 and the size of the display area HT-1 without changing the object position 200P-1. The object 200-1 in which the spread size of the object beam L-1 and the size of the display area HT-1 are changed is set as an object 200-11. An object beam L-11 from the object 200-11 has a small spread size than that of the object beam L-1 on the display surface H1. A display area HT-11 of the object 200-11 is smaller than the display area HT-1. The spread size of the object beam L-1 and a reduction ratio of the size of the display area HT-1 are set based on, for example, a distance from the object position 200P-1 to the display surface H1 and the overlap HK. Accordingly, in the display medium 11, the display area HT-11 of the object 200-11 and the display area HT-2 of the object 200-2 do not overlap each other.

As illustrated in FIG. 17, the information processing apparatus 20 repeatedly performs wavefront propagation calculation using the diffraction formula between the display surface H1 of the display medium 11 and the object position 200P of the object 200 by the GS algorithm as the iterative method described above. The information processing apparatus 20 fixes the amplitude A1 to the amplitude A0, which is an initial value with a fixed value of 1, on the display surface H1. At the object position 200P, an amplitude A3 is fixed to an amplitude Aobj of an optimization target obtained from the image data 21A. The control unit 22 calculates an amplitude A2 and a phase P2 at the object position 200P by the wavefront propagation calculation of the amplitude A1 and a phase P1 of the display surface H1. The control unit 22 sets the amplitude Aobj to the amplitude A3 and the phase P2 to the phase P3, and calculates an amplitude A4 and a phase P4 of the display surface H1 by the wavefront propagation calculation of the amplitude A3 and the phase P3 at the object position 200P. The control unit 22 sets the phase P4 to the phase P1 and calculates the amplitude A2 and the phase P2 at the object position 200P by the wavefront propagation calculation of the amplitude A1 and the phase P1 of the display surface H1. By repeating the wavefront propagation calculation, the control unit 22 brings the amplitude A2 close to the amplitude Aobj and brings the amplitude A4 close to a constant value. As a result, the phase P1 is narrowed from a display area HT-B before the change to a display area HT-A after the change. In the phase P1, a difference HTE between the display area HT-B before the change and the display area HT-A after the change is filled with a 0 value that is the fixed value, or a strong band limitation is applied.

As illustrated in the right diagram of FIG. 16, the information processing apparatus 20 displays the hologram data 21D on the display medium 11 based on the changed object 200-11. The spread of the object beam L-11 of the object 200-11 is smaller than the spread of the object beam L-1 of the object 200-1 before the change. There is no change in the object beam L-2 of the object 200-2. As a result, in the display medium 11, the display area HT-11 of the object 200-11 becomes smaller than the display area HT-1, and does not overlap the display area HT-2 of the object 200-2.

A left diagram of FIG. 18 is the same as the left diagram of FIG. 7 described above. In other words, as illustrated in the left diagram of FIG. 18, the object beam L-1 and the object beam L-2 at the two object positions 200P-1 and 200P-2 partially overlap with respect to the display area HT-1 and the display area HT-2 on the display surface H1 of the display medium 11. When the overlap HK of the display area HT-1 and the display area HT-2 is detected, the information processing apparatus 20 changes a spread shape of the object beam L of the object 200 and a shape of the display area HT so as to achieve an arrangement that eliminates the overlap HK between the display areas HT. A method of changing the shape can be realized, for example, by changing a shape of the display area HT-A in FIG. 17.

In the example illustrated in the right diagram of FIG. 18, the object 200-2 is close to the edge of the display surface H1, and the movable space of the object 200-1 is also limited in the information processing apparatus 20. In order to eliminate the overlap HK in the display area HT-1, the information processing apparatus 20 changes the spread shape of the object beam L-1 of the object 200-1 and the shape of the display area HT-1 without changing the object position 200P-1. The object 200-1 in which the spread shape of the object beam L and the shape of the display area HT are changed is defined as an object 200-12. The spread shape of an object beam L-12 of the object 200-12 can be deformed so as to reduce the spread shape or can be asymmetrically deformed so that the overlap HK between the display area HT-1 and the display area HT-2 is eliminated. For example, the information processing apparatus 20 changes the spread shape from a circular shape of the object beam L-1 to a substantially elliptical shape of the object beam L-12. The information processing apparatus 20 displays the hologram data 21D on the display medium 11 based on the changed spread shape of the object beam L-12. The spread of the object beam L-12 of the object 200-12 is smaller than the spread of the object beam L-1 of the object 200-1 before the change. There is no change in the object beam L-2 of the object 200-2. As a result, in the display medium 11, the display area HT-12 of the object 200-12 becomes smaller than the display area HT-1, and does not overlap the display area HT-2 of the object 200-2.

### [Example of Processing Procedure of Information Processing Apparatus According to Second Embodiment]

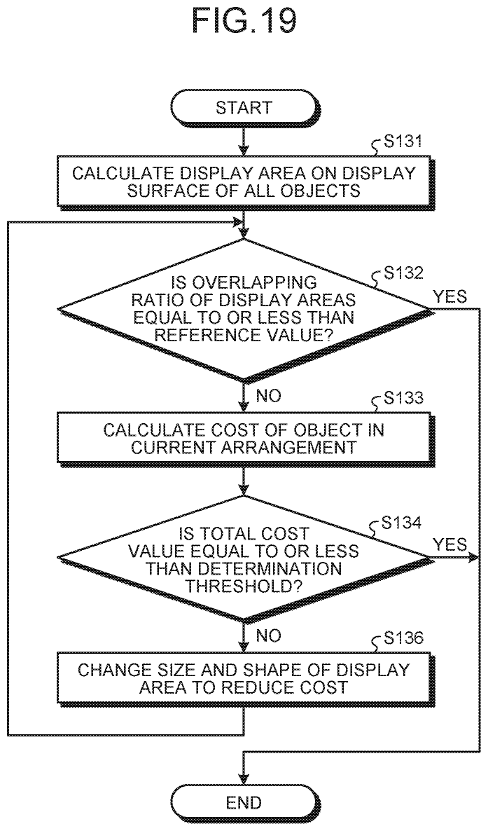

The information processing apparatus 20 according to the second embodiment can use the processing procedure described in the first embodiment described above. Hereinafter, in the processing procedure according to the second embodiment, a processing procedure different from that of the first embodiment will be described. For example, the processing procedure according to the second embodiment can be realized by changing the spatial arrangement control process illustrated in FIG. 11 to the processing procedure illustrated in FIG. 19. FIG. 19 is a flowchart illustrating an example of the spatial arrangement process according to the second embodiment.

The control unit 22 executes the spatial arrangement control process of the object 200 illustrated in FIG. 10 (Step S13). The spatial arrangement control process includes, for example, a process of changing a spatial arrangement of the objects 200 based on the overlap HK of the display areas HT of the objects 200 on the display surface H1.

### [Spatial Arrangement Control Process]

For example, when the spatial arrangement control process illustrated in FIG. 19 is executed, the control unit 22 calculates the display areas HT of all the objects 200 on the display surface H1 (Step S131). The control unit 22 determines whether or not the overlapping ratio of the display areas HT is equal to or less than the reference value (Step S132). When it is determined that the overlapping ratio of the display areas HT is equal to or less than the reference value (Yes in Step S132), the control unit 22 ends the spatial arrangement control process illustrated in FIG. 19, since there is no need to change the arrangement of the objects 200, and returns the process to Step S13 illustrated in FIG. 10.

When the overlapping ratio of the display areas HT is determined to be greater than the reference value (No in Step S132), the control unit 22 advances the process to Step S133. The control unit 22 calculates cost of the objects 200 in the current arrangement (Step S133). After storing, in the storage unit 21, the cost of the objects 200 in the current arrangement calculated using the evaluation function, the control unit 22 advances the process to Step S134.

The control unit 22 determines whether or not a total cost value is equal to or less than a determination threshold (Step S134). When the control unit 22 determines that the total cost value is greater than the determination value, i.e., when it is determined that the arrangement of the objects 200 needs to be changed (No in Step S134), the process advances to Step S136.

The control unit 22 changes the size and shape of the display area HT so as to reduce the cost (Step S136). For example, the control unit 22 changes the size and shape of a space area HT in a direction of decreasing the total cost value. For example, the control unit 22 identifies an object 200 that causes high cost, and changes the spread size and shape of the object beam L of the object 200 identified. Alternatively, the control unit 22 changes the spread size and shape of the object beam L of the object 200 around the object 200 identified. When the process in Step S136 is completed, the control unit 22 returns the process to Step S132 described above and continues the process. In other words, the control unit 22 executes processing on the object 200 whose size and shape have been changed.

Furthermore, when the total cost value is equal to or less than the determination value, i.e., when it is determined that there is no need to change the arrangement of the objects 200 (Yes in Step S134), the control unit 22 ends the spatial arrangement control process illustrated in FIG. 19 and returns the process to Step S13 illustrated in FIG. 10.

Returning to FIG. 10, when the process in Step S13 is completed, the control unit 22 sets an initial phase (Step S14). For example, the control unit 22 uniformly changes the phase according to the XY coordinates with respect to a pixel value of the object beam data 21B, thereby acquiring complex amplitude of the amplitude and the phase of the object beam L for each pixel. The control unit 22 sets the phase acquired as the initial phase in the object beam data 21B. When the process in Step S14 is completed, the control unit 22 ends the object beam generation process illustrated in FIG. 10 and returns the process to Step S10 illustrated in FIG. 9.

As described above, when the plurality of display areas HT overlaps each other, the information processing apparatus 20 according to the second embodiment can change at least one of the amplitude and the phase of the object 200 so as to achieve at least one of the size and the shape that eliminates the overlap HK of the plurality of display areas HT. Accordingly, the information processing apparatus 20 can suppress the plurality of object beams L from overlapping on the display surface H1. As a result, the information processing apparatus 20 can reproduce the object beams L of the plurality of objects 200 with further higher image quality on the display medium 11. Furthermore, the information processing apparatus 20 can more reliably maintain the stereoscopic effect without making the depth of field of the plurality of objects 200 too deep.

Note that the information processing apparatus 20 according to the second embodiment may be applied to or combined with the information processing apparatus 20 of another embodiment or modification. For example, by executing the first embodiment and the second embodiment in combination, it is possible to simultaneously change the spatial arrangement of the object 200 and the size and shape of the display area HT, which is suitable for a complicated object 200.

### Third Embodiment

Next, an example of an information processing apparatus 20 according to a third embodiment will be described. In the second embodiment, the size of the display area HT is limited by filling an outside of the display area HT with 0, i.e., by applying strong band limitation to a phase distribution during iterative calculation. Since a light spread angle varies depending on a spatial frequency of the object beam L, the space area HT can be substantially reduced by limiting the band. In the case of phase modulation, the size of the space area HT is substantially controlled by applying the band limitation to an initial phase or a phase distribution in the middle of the iterative calculation method. As illustrated in FIG. 3, limiting the signal band is substantially equivalent to increasing a pixel pitch P. When the band limitation is weak, the phase approaches a random phase of 0 to 2 π, and when the band limitation is strong, the phase approaches a fixed phase.

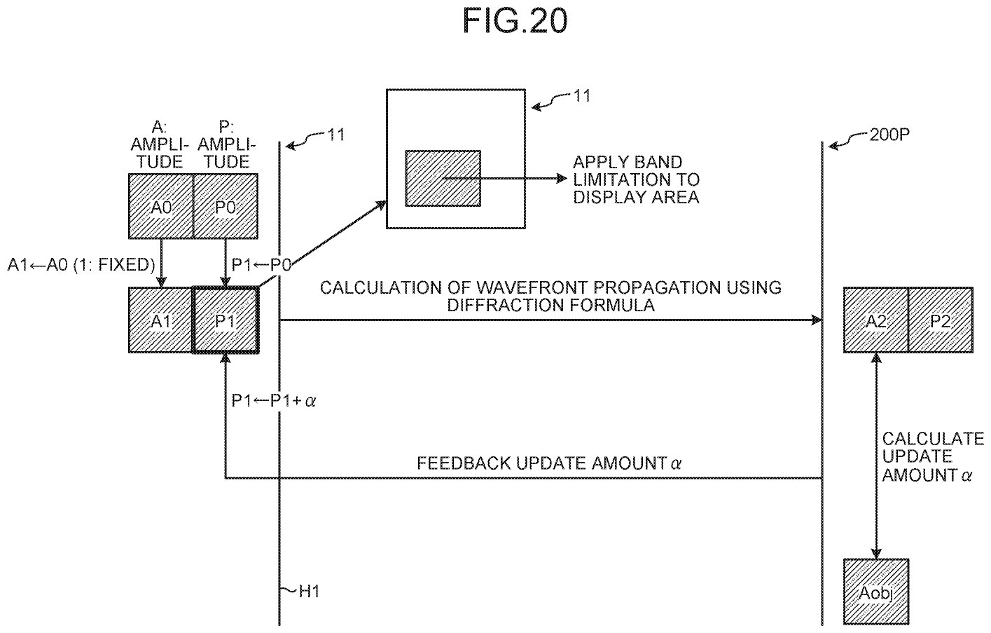

FIG. 20 is a diagram illustrating an example of phase modulation by optimization in the information processing apparatus 20 according to the third embodiment. In the example illustrated in FIG. 20, a case where the phase modulation is performed using Wirtinger Holography as the optimization process will be described, but the GS algorithm described above may also be used as the optimization process. As illustrated in FIG. 20, the control unit 22 of the information processing apparatus 20 repeatedly performs wavefront propagation calculation using a diffraction formula between the display surface H1 of the display medium 11 and the object position 200P of the object 200, and gives a constraint condition between the display surface H1 and the object position 200P. For example, on the display surface H1, an amplitude A1 is fixed to an amplitude A0, which is an initial value with a fixed value of 1. At the object position 200P, an amplitude A3 is fixed to an amplitude Aobj of an optimization target obtained from the image data 21A. The control unit 22 applies the band limitation to the phase P1, and calculates the amplitude A2 and the phase P2 at the object position 200P by the wavefront propagation calculation of the amplitude A1 and the phase P1 of the display surface H1. The control unit 22 obtains an update amount α based on the amplitude A2, the phase P2, and the amplitude Aobj. The control unit 22 feeds back the update amount α to the display surface H1, and the update amount α is added to the phase P1 to update the phase P1. The control unit 22 calculates an amplitude A2 and a phase P2 at the object position 200P by the wavefront propagation calculation of the amplitude A1 and a phase P1 of the display surface H1. By repeating the wavefront propagation calculation, the control unit 22 brings the amplitude A2 close to the amplitude Aobj and applies the band limitation to the phase P1. The control unit 22 stores, in the storage unit 21, a result of the complex amplitude optimization process.

An information processing system 1 according to the third embodiment has the same configuration as the information processing system 1 according to the first embodiment.

### [Example of Processing Procedure of Information Processing Apparatus According to Third Embodiment]

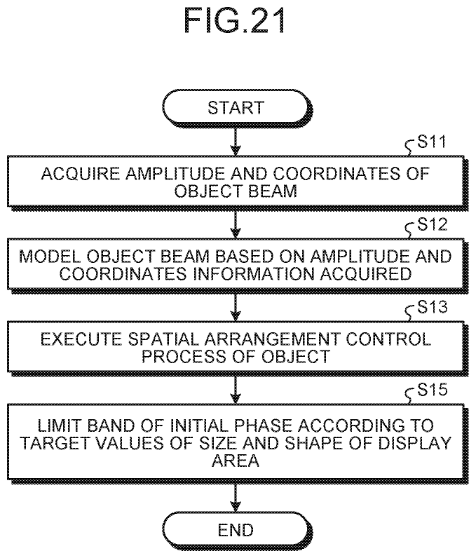

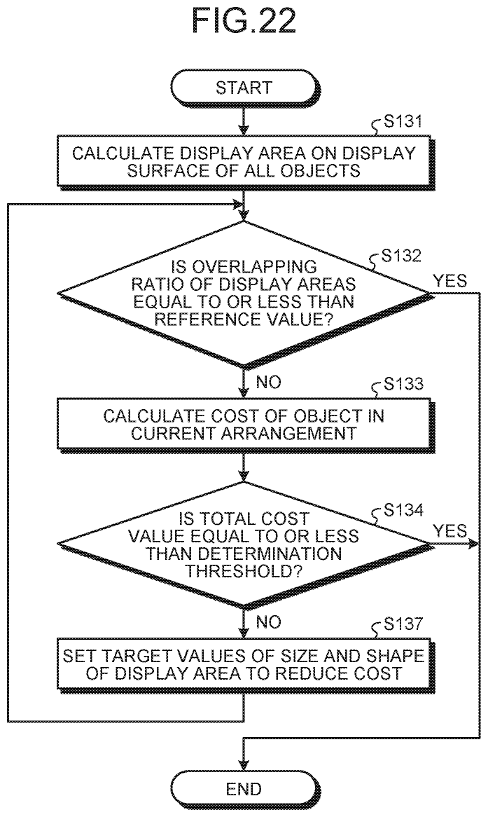

The information processing apparatus 20 according to the third embodiment can use the processing procedure described in the first embodiment described above. Hereinafter, in the processing procedure according to the third embodiment, a processing procedure different from that of the first embodiment will be described. For example, the processing procedure according to the third embodiment can be realized by changing the object beam generation process illustrated in FIG. 10 to a processing procedure illustrated in FIG. 21. For example, the processing procedure according to the third embodiment can be realized by changing the spatial arrangement control process illustrated in FIG. 11 to a processing procedure illustrated in FIG. 22. FIG. 21 is a flowchart illustrating an example of the object beam generation process according to the third embodiment. FIG. 22 is a flowchart illustrating an example of the spatial arrangement control process according to the third embodiment.

### [Object Beam Generation Process]

After executing the object beam generation process in Step S10 illustrated in FIG. 9, the control unit 22 starts the processing procedure of the object beam generation process illustrated in FIG. 21. The control unit 22 acquires an amplitude and coordinates of the object beam L (Step S11). The control unit 22 models the object beam L based on amplitude and coordinates information acquired (Step S12). The control unit 22 executes the spatial arrangement control process of the objects 200 (Step S13).

### [Spatial Arrangement Control Process]

For example, when the spatial arrangement control process illustrated in FIG. 22 is executed, the control unit 22 calculates the display areas HT of all the objects 200 on the display surface H1 (Step S131). The control unit 22 determines whether or not the overlapping ratio of the display areas HT is equal to or less than the reference value (Step S132). When it is determined that an overlapping ratio of the display areas HT is equal to or less than a reference value (Yes in Step S132), the control unit 22 ends the spatial arrangement control process illustrated in FIG. 22, since there is no need to change the arrangement of the objects 200, and returns the process to Step S13 illustrated in FIG. 21.

When the overlapping ratio of the display areas HT is determined to be greater than the reference value (No in Step S132), the control unit 22 advances the process to Step S133. The control unit 22 calculates cost of the objects 200 in the current arrangement (Step S133). After storing, in the storage unit 21, the cost of the objects 200 in the current arrangement calculated using the evaluation function, the control unit 22 advances the process to Step S134.

The control unit 22 determines whether or not a total cost value is equal to or less than a determination threshold (Step S134). When the control unit 22 determines that the total cost value is greater than the determination value, i.e., when the arrangement of the objects 200 needs to be changed (No in Step S134), the process advances to Step S137.

The control unit 22 sets target values of the size and shape of the display area HT so as to reduce the cost (Step S137). For example, the control unit 22 changes the size and shape of the display area HT using database, in which parameters for lowering the total cost value are accumulated, and machine learning. For example, the control unit 22 identifies the display area HT that causes high cost, and changes the target values of the size and shape of the display area HT identified or changes the target values of the size and shape of the display area HT around the display area HT identified. When the process in Step S137 is completed, the control unit 22 returns the process to Step S132 described above and continues the process. In other words, the control unit 22 executes processing on the display area HT whose target values of the size and shape have been changed.

Furthermore, when the total cost value is equal to or less than the determination value, i.e., when it is determined that there is no need to change the arrangement of the objects 200 (Yes in Step S134), the control unit 22 ends the spatial arrangement control process illustrated in FIG. 22 and returns the process to Step S13 illustrated in FIG. 21.

Returning to FIG. 21, when the process in Step S13 is completed, the control unit 22 limits the band of the initial phase according to the target values of the size and shape of the display area HT (Step S15). For example, the control unit 22 uniformly changes the phase of the pixel value of the object beam data 21B according to XY coordinates, thereby limiting the band of the initial phase between the amplitude and the phase of the object beam L for each pixel. The control unit 22 sets the phase acquired as the initial phase in the object beam data 21B. When the process in Step S15 is completed, the control unit 22 ends the object beam generation process illustrated in FIG. 21 and returns the process to Step S10 illustrated in FIG. 9.

As described above, when the plurality of display areas HT overlaps each other, the information processing apparatus 20 according to the third embodiment can change at least one of the amplitude and the phase of the object 200 so as to obtain the band of the object beam L that eliminates the overlap HK of the plurality of display areas HT. Accordingly, since the information processing apparatus 20 can limit the band of the initial phase, it is possible to suppress the plurality of object beams L from overlapping on the display surface H1. As a result, the information processing apparatus 20 can reproduce the object beams L of the plurality of objects 200 with further higher image quality on the display medium 11. Furthermore, the information processing apparatus 20 can more reliably maintain the stereoscopic effect without making the depth of field of the plurality of objects 200 too deep.

Note that the information processing apparatus 20 according to the third embodiment may be applied to or combined with the information processing apparatus 20 of another embodiment or modification. For example, by combining the first embodiment and the third embodiment, it is possible to simultaneously change the spatial arrangement of the object 200 and the band of the initial phase.

### Fourth Embodiment

Next, an example of an information processing apparatus 20 according to a fourth embodiment will be described. For example, in a case where object beams L of a plurality of objects 200 are simultaneously displayed, there is a case where it is desired to set the priority. For example, similarly to the first embodiment, there is a need for the information processing system 1 to arrange a speed at a fixed position and change a display position of other information according to a positional relation with a real object when an OSD display is performed or when navigation including the speed, route, and destination of the vehicle is displayed.

For example, when it is desired to display an object 200 related to safety such as a vehicle speed so as to ensure that the user can visually recognize the object, the information processing system 1 needs to avoid disturbance of this object by another object 200. Therefore, the information processing system 1 according to the fourth embodiment sets the priority of the plurality of objects 200. When the plurality of display areas HT overlaps each other, the change unit 22B of the control unit 22 provides a function of changing at least one of the amplitude and the phase of the object 200 based on the priority of the objects 200 corresponding to the display areas HT so as to achieve an arrangement that eliminates the overlap of the display area HT with another display area HT.

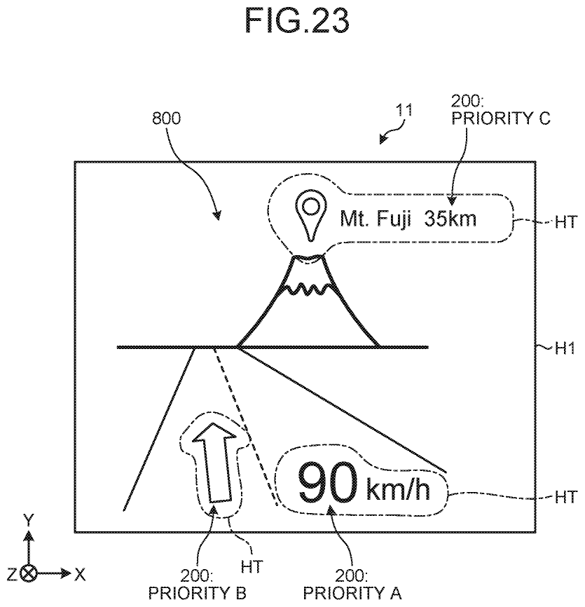

FIG. 23 is a diagram illustrating an example of a processing outline of the information processing apparatus 20 according to the fourth embodiment. In the example illustrated in FIG. 23, the information processing apparatus 20 gives a highest priority A to the object 200 indicating the speed, a next highest priority B to the object 200 indicating the route, and a lowest priority C to the object 200 indicating the destination. Therefore, when the display area HT of the object 200 indicating the speed overlaps another display area HT, the information processing apparatus 20 changes at least one of the amplitude and the phase of the another object 200.

### [Example of Function Outline of Information Processing Apparatus According to Fourth Embodiment]

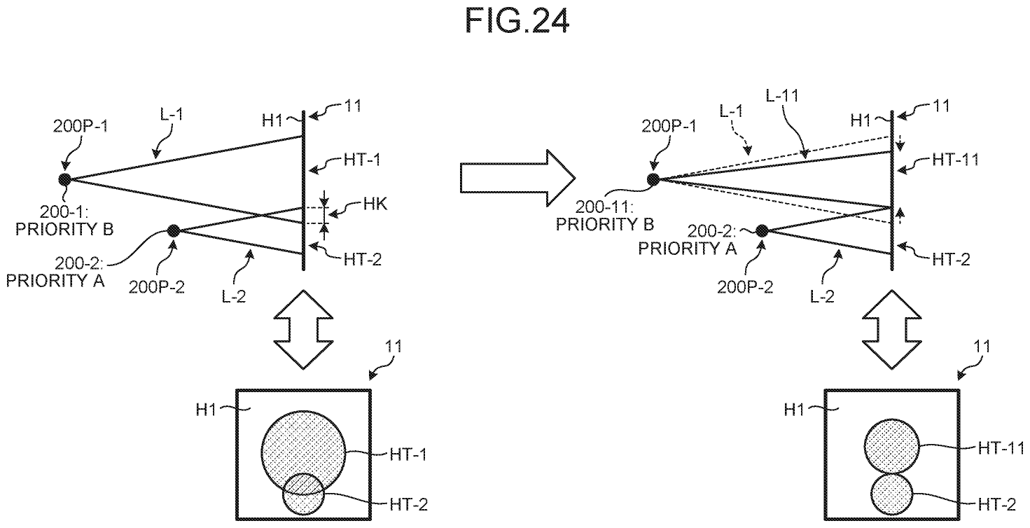

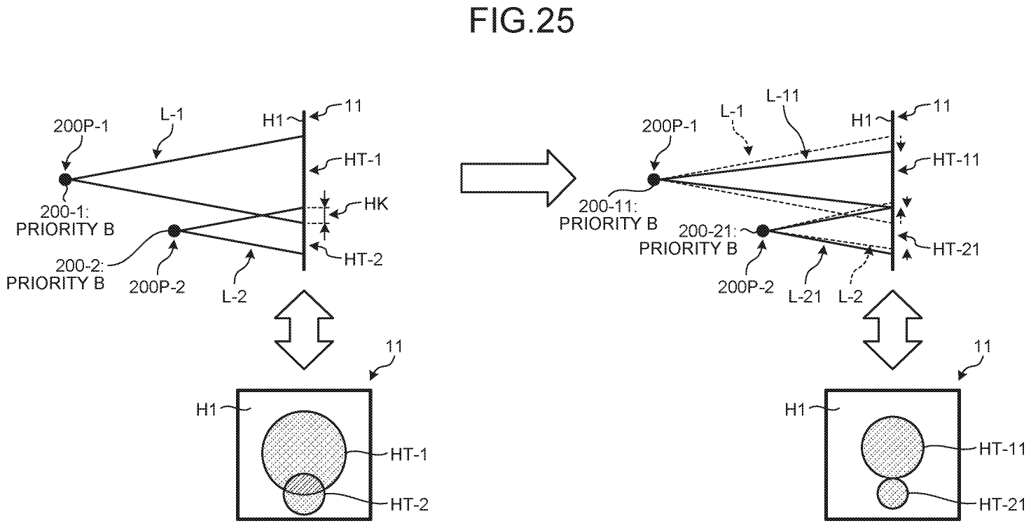

FIG. 24 is a diagram illustrating an example of a function outline of the information processing apparatus 20 according to the fourth embodiment. FIG. 25 is a diagram illustrating an example of phase modulation by optimization in the information processing apparatus 20 according to the fourth embodiment.

An information processing system 1 according to the fourth embodiment has the same configuration as the information processing system 1 according to the first embodiment. The image data 21A is associated with information indicating the priority of each of the objects 200.

A left diagram of FIG. 24 is the same as the left diagram of FIG. 7 described above. In other words, as illustrated in the left diagram of FIG. 24, the object beam L-1 and the object beam L-2 at the two object positions 200P-1 and 200P-2 partially overlap with respect to the display area HT-1 and the display area HT-2 on the display surface H1 of the display medium 11. When the overlap HK between the display area HT-1 and the display area HT-2 is detected, the information processing apparatus 20 changes the arrangement of the display areas HT so as to achieve an arrangement that eliminates the overlap HK between the display areas HT.

In an example illustrated in FIG. 24, in the information processing apparatus 20, the object 200-2 has the priority A, and the object 200-1 has the priority B. The information processing apparatus 20 changes the object 200-1 with the priority B or changes the display area HT-1. In order to eliminate the overlap HK in the display area HT-1, the information processing apparatus 20 reduces the spread shape size of the object beam L-1 of the object 200-1 and the size of the display area HT-1 without changing the object position 200P-1. In FIG. 24, the object 200-1 whose size has been changed is set as an object 200-11. In an example illustrated in a right diagram of FIG. 24, the information processing apparatus 20 sets the spread shape size of the object beam L-1 of the object 200-1 and a reduction ratio of the size of the display area HT-1 based on, for example, a distance from the object position 200P-1 to the display surface H1 and the overlap HK. Accordingly, in the display medium 11, the display area HT-11 of the object 200-11 and the display area HT-2 of the object 200-2 do not overlap each other.

Next, a left diagram of FIG. 25 is the same as the left diagram of FIG. 7 described above. In other words as illustrated in the left diagram of FIG. 25, the object beam L-1 and the object beam L-2 at the two object positions 200P-1 and 200P-2 partially overlap with respect to the display area HT-1 and the display area HT-2 on the display surface H1 of the display medium 11. When the overlap HK between the display area HT-1 and the display area HT-2 is detected, the information processing apparatus 20 changes the arrangement of the display areas HT on the display surface H1 so as to achieve an arrangement that eliminates the overlap HK between the display area HT-1 and the display area HT-2.

In an example illustrated in FIG. 25, the object 200-1 and the object 200-2 have the same priority B in the information processing apparatus 20. The information processing apparatus 20 changes the spread shape sizes of the object beam L-1 and the object beam L-2 of both the object 200-1 and the object 200-2 to an object beam L-11 and an object beam L-21. The information processing apparatus 20 changes the sizes of the display area HT-1 and the display area HT-2 of both the object 200-1 and the object 200-2 to a display area HT-11 and a display area HT-21. The information processing apparatus 20 changes the spread shape sizes of the object beam L-1 and the object beam L-2 and the sizes of the display area HT-1 and the display area HT-2 in order to eliminate the overlap HK of the display areas HT. In the example illustrated in a right diagram of FIG. 25, the information processing apparatus 20 sets the reduction ratios of the spread sizes of the object beam L-1 and the object beam L-2 and the sizes of the display area HT-1 and the display area HT-2 based on, for example, distances from the object positions 200P-1 and 200P-2 to the display surface H1 and the overlap HK. Accordingly, in the display medium 11, the display area HT-11 of the object 200-11 and the display area HT-21 of the object 200-21 do not overlap each other.

### [Spatial Arrangement Control Process]

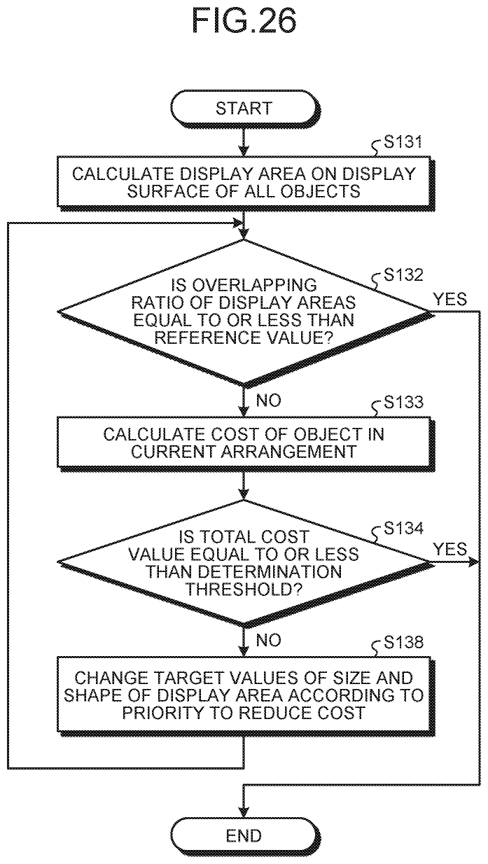

FIG. 26 is a flowchart illustrating an example of a spatial arrangement process according to the fourth embodiment. In the fourth embodiment, the above-described spatial arrangement process illustrated in FIG. 11 may be replaced with the spatial arrangement process illustrated in FIG. 26. The processing procedure illustrated in FIG. 26 is the same as the basic procedure of the spatial arrangement process illustrated in FIG. 11. The spatial arrangement process is executed by the control unit 22 in Step S13 in FIG. 10 described above.

For example, when Step S13 illustrated in FIG. 10 described above is executed, the control unit 22 calculates the display areas HT on the display surface H1 of all the objects 200 (Step S131). The control unit 22 determines whether or not the overlapping ratio of the display areas HT is equal to or less than the reference value (Step S132). When it is determined that the overlapping ratio of the display areas HT is equal to or less than the reference value (Yes in Step S132), the control unit 22 ends the spatial arrangement control process illustrated in FIG. 26, since there is no need to change the arrangement of the objects 200, and returns the process to Step S13 illustrated in FIG. 10.

When the overlapping ratio of the display areas HT is determined to be greater than the reference value (No in Step S132), the control unit 22 advances the process to Step S133.

The control unit 22 calculates cost of the objects 200 in the current arrangement (Step S133). The control unit 22 determines whether or not a total cost value is equal to or less than a determination threshold (Step S134). When the control unit 22 determines that the total cost value is greater than a determination value, i.e., when it is determined that the arrangement of the objects 200 needs to be changed (No in Step S134), the process advances to Step S138.

The control unit 22 changes the size and shape of the display area HT to target values according to the priority in a direction of lowering the cost (Step S138). For example, the control unit 22 groups the plurality of objects 200 based on the priority, and identifies an object 200 that causes a high cost among a group of objects with low priority. The control unit 22 changes the size and shape of the display area HT of the object 200 identified to the target values by changing the object position 200P of the object 200 identified or changing the size and shape of the object 200 identified. When the process in Step S138 is completed, the control unit 22 returns the process to Step S132 described above and continues the process. In other words, the control unit 22 executes processing on the objects 200 whose spatial arrangement has been changed.

Furthermore, when the total cost value is equal to or less than the determination value, i.e., when it is determined that there is no need to change the arrangement of the objects 200 (Yes in Step S134), the control unit 22 ends the spatial arrangement control process illustrated in FIG. 26 and returns to the process in Step S13 illustrated in FIG. 10.

Returning to FIG. 10, when the process in Step S13 is completed, the control unit 22 sets an initial phase (Step S14). For example, the control unit 22 uniformly changes the phase according to the XY coordinates with respect to a pixel value of the object beam data 21B, thereby acquiring complex amplitude of the amplitude and the phase of the object beam L for each pixel. The control unit 22 sets the phase acquired as the initial phase in the object beam data 21B. When the process in Step S14 is completed, the control unit 22 ends the object beam generation process illustrated in FIG. 10 and returns the process to Step S10 illustrated in FIG. 9.

Returning to FIG. 9, when the process in Step S10 is completed, the control unit 22 advances the process to Step S20. The control unit 22 executes the wavefront propagation calculation process (Step S20). The wavefront propagation calculation process includes, for example, a process of calculating wavefront propagation based on the object beam data 21B.

As described above, when the plurality of display areas HT overlaps each other, the information processing apparatus 20 according to the fourth embodiment can change at least one of the amplitude and the phase of the object 200 based on the priority of the objects 200 corresponding to the display areas HT so as to achieve an arrangement that eliminates the overlap of the display area HT with another display area HT. Accordingly, the information processing apparatus 20 can suppress the plurality of object beams L from overlapping on the display surface H1 in consideration of the priority of the plurality of objects 200. As a result, the information processing apparatus 20 can reproduce the object beams L of the plurality of objects 200 with further higher image quality on the display medium 11. Furthermore, the information processing apparatus 20 can more reliably maintain the stereoscopic effect without making the depth of field of the plurality of objects 200 too deep.

Furthermore, when the plurality of display areas HT overlaps each other, the information processing apparatus 20 can change at least one of the amplitude and the phase of the object 200 having a low priority, based on the priority of the objects 200 corresponding to the display area HT, among the objects 200 corresponding to the overlapping display areas HT. Accordingly, the information processing apparatus 20 can prevent the display position of the object 200 with high priority from being changed by changing the object 200 with low priority. As a result, the information processing apparatus 20 can ensure the visibility of display using the display medium 11 since the object 200 with high priority is not hindered by the object 200 with low priority.

Note that the information processing apparatus 20 according to the fourth embodiment may be applied to or combined with the information processing apparatus 20 of another embodiment or modification. The fourth embodiment may be combined with at least one of the first embodiment, the second embodiment, and the third embodiment.

### Fifth Embodiment

Next, an example of an information processing apparatus 20 according to a fifth embodiment will be described. For example, in a case where the object beams L of the plurality of objects 200 are simultaneously displayed, there is a case where the overlap HK of the display areas HT cannot be avoided due to a restriction of a spatial arrangement. In the fifth embodiment, an information processing system 1 provides a function of optimizing the image quality by controlling the display areas HT within a possible range.

For example, when the plurality of objects 200 indicated by the image data 21A has a multilayer structure, there are two types of optimization system using the iterative method. Multilayer means to have a plurality of different layers.

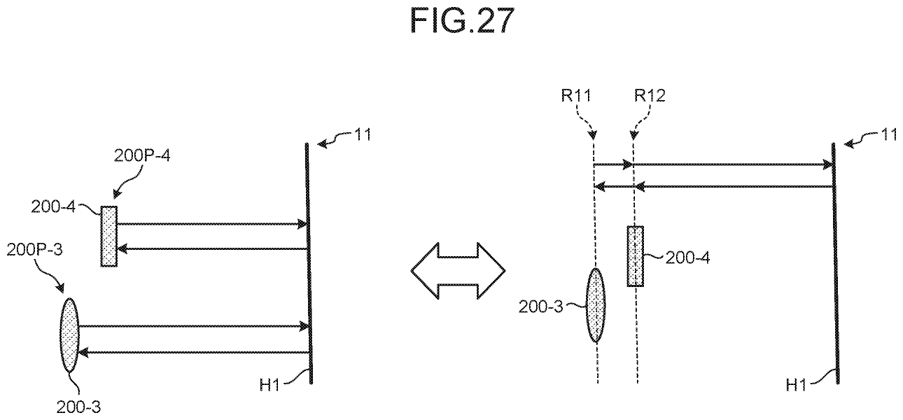

FIG. 27 is a diagram illustrating multilayer processing of the information processing apparatus 20 according to the fifth embodiment. A left diagram of FIG. 27 illustrates a parallel method. A right diagram of FIG. 27 illustrates a series method. The information processing apparatus 20 uses the parallel method and a direct method. The parallel method is a method in which each layer is independently looped for iterative calculation to generate the wavefront data 21C on the display surface H1, and then the wavefront data 21C of all layers is integrated. The series method is a method of integrating all layers and looping the iterative calculation in consideration of a complex amplitude distribution of all layers to generate wavefront data on the display surface H1. The series method can be performed in combination with the first to fourth embodiments.

For example, in the display medium 11, wavefront propagation calculation is performed in order from a distant view to a near view. The left diagram of FIG. 27 illustrates an example of the parallel method. In the display medium 11, an object position 200P-3 and an object position 200P-4 are different, and an object 200-3 and an object 200-4 are three-dimensional. When the display medium 11 is referred to from the XY plane, the object 200-3 and the object 200-4 are visually recognized without overlapping.

The right diagram of FIG. 27 illustrates an example of the series method. In the display medium 11, the object 200-4 is positioned in front of the object 200-3 in the depth direction indicated by the Z axis. A plane passing the object 200-3 is a layer R11, and a plane passing the object 200-4 is a layer R12. The layer R12 is closer to the display surface H1 than the layer R11. In the example illustrated in FIG. 27, each of the layer R11 and the layer R12 may include a plurality of objects 200. When the display medium 11 is referred to from the XY plane, a part of the object 200-3 is visually recognized to overlap the object 200-4.

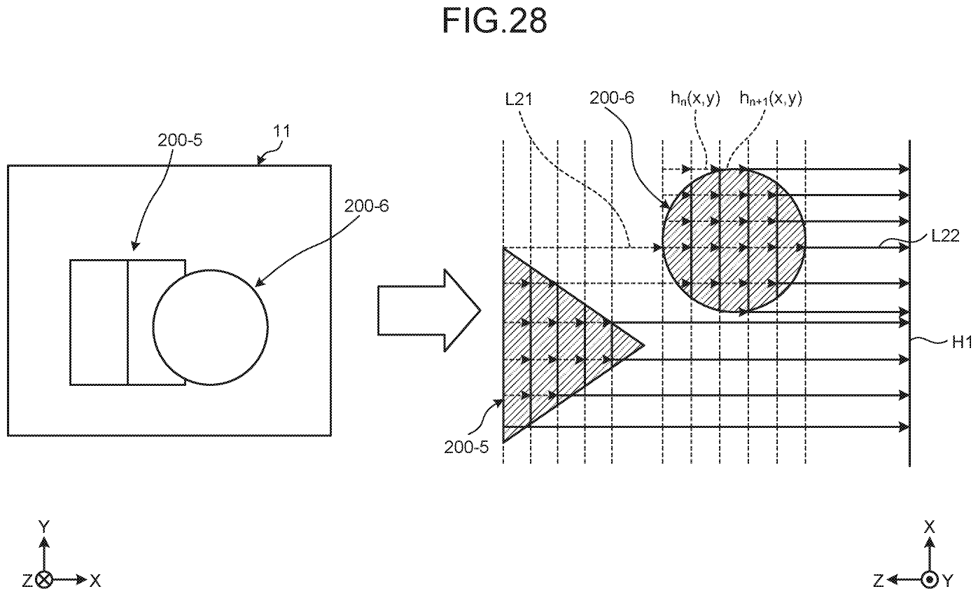

FIG. 28 is a diagram illustrating an example of a hidden surface process of the display medium 11. The hidden surface process is an example of the series method. A right diagram of FIG. 28 illustrates the depth direction (Z-axis direction) of a left diagram of FIG. 28 from above. As illustrated in the right diagram of FIG. 28, the display medium 11 performs the wavefront propagation in the order from a back layer to a front layer in the depth direction. Object beam L of the back layer is blocked by the front layer, and is replaced with object beam L of the front layer. For example, light beam L21 of an object 200-5 is blocked by an object 200-6 and replaced with light beam L22 that is the object beam L of the object 200-1. The light beam L22 of the object 200-6 reaches the display surface H1.

The display medium 11 is subjected to the hidden surface process for erasing a portion of the object 200 not visible from the viewpoint. The hidden surface process can use Expression (2) for processing wavefront of a preceding stage and Expression (3) for processing wavefront of the display surface H1. The preceding stage means a layer closer to the display surface H1 among the layers. A subsequent stage means a layer at the back of the preceding stage in the depth direction among the layers. The foremost stage means a layer closest to the display surface H1.

hₙ₊₁(x, y)=Pₙ(mₙ(x, y)×hₙ(x, y)+Oₙ(x, y)) Expression (2)

h_{hologram}(x, y)=P_{N}(m_{N}(x, y)×h_{N}(x, y)+O_{N}(x, y)) Expression (3)

In Expressions (1) and (2), n and N are integers, and a value increases as approaching the display surface H1. hₙ₊₁ (x, y) indicates a wavefront of the (n+1) th layer (preceding stage). mₙ (x, y) indicates a mask function of the nth layer (subsequent stage). When the value is “0”, mₙ (x, y) indicates inside the object. When the value is “1”, mₙ (x, y) indicates outside the object. hₙ (x, y) is the wavefront of the nth layer. Pₙ is a wavefront propagation operator. n is an integer. Oₙ (x, y) indicates the object beam of the nth layer. m_{N} (x, y) represents a mask function of the frontmost layer. h_{N} (x, y) is the wavefront of the frontmost layer. P_{N} is a wavefront propagation operator. O_{N} (x, y) indicates the object beam L of the frontmost layer.

In the case of the series method, the information processing apparatus 20 according to the fifth embodiment performs the wavefront propagation calculation so as to recoat in the order from the distant view to the near view. The information processing apparatus 20 performs the wavefront propagation sequentially from the back layer to the front layer. The information processing apparatus 20 replaces the object beam L of the back layer blocked by the front layer with the object beam L of the front layer.

### [Schematic Configuration of Information Processing System]

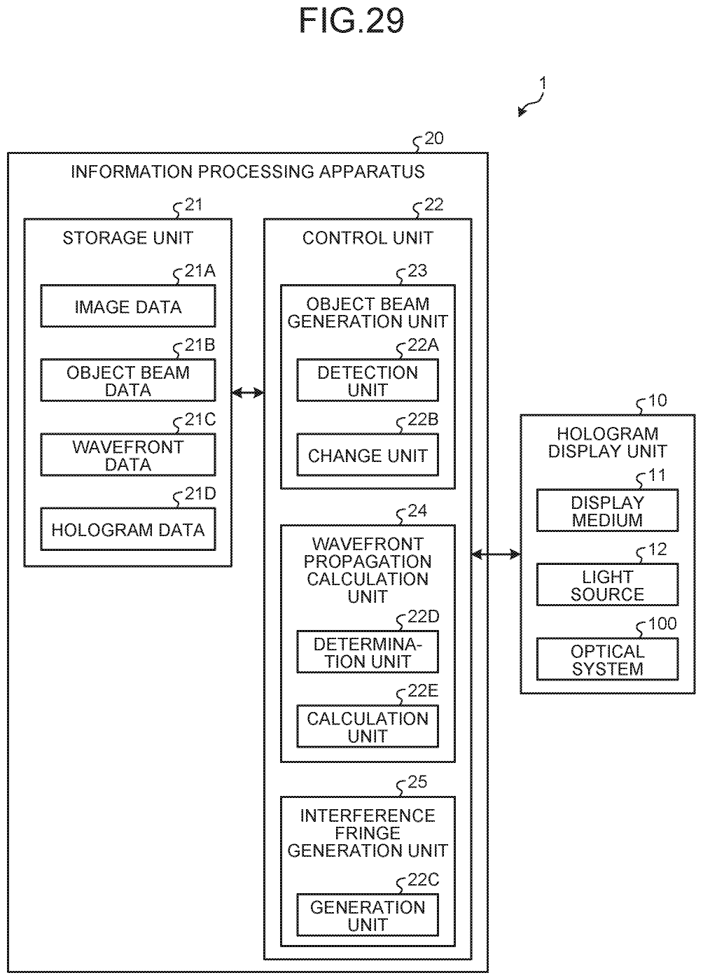

FIG. 29 is a diagram illustrating a schematic configuration of an information processing system 1 according to the fifth embodiment. The information processing system 1 illustrated in FIG. 29 has the same basic configuration illustrated in FIG. 5. In the information processing apparatus 20, the wavefront propagation calculation unit 24 of the control unit 22 further includes functional units of a determination unit 22D and a calculation unit 22E. The determination unit 22D and the calculation unit 22E are implemented by the control unit 22 executing a program.

The determination unit 22D determines an optimization system of complex amplitude of the object 200 based on the overlapping ratio between the display area HT of the object 200 and the display area HT of another object 200. For example, the determination unit 22D determines whether the optimization system using the iterative method is the parallel method or the series method. The determination unit 22D determines to use the parallel method as the optimization system of the object 200 when there is no overlap HK. The determination unit 22D determines to use the series method as the optimization system of the object 200 when the overlap HK exists.

The calculation unit 22E calculates the complex amplitude of the object 200 on the display surface H1 using the optimization system determined. When the parallel method is determined, the calculation unit 22E independently loops the iterative calculation of each of the objects 200, generates the wavefront data 21C on the display surface H1, and then integrates the wavefront data 21C of all layers. When the series method is determined, the calculation unit 22E integrates all the layers and then loops the iterative calculation in consideration of the complex amplitude distribution in all the layers to generate the wavefront data 21C on the display surface H1.

The configuration example of the information processing apparatus 20 according to the fifth embodiment has been described above. Note that the functional configuration described above with reference to FIG. 29 is merely an example, and the functional configuration of the information processing apparatus 20 according to the present embodiment is not limited thereto. The functional configuration of the information processing apparatus 20 according to the present embodiment can be flexibly modified according to specifications and operations.

### [Wavefront Propagation Calculation Process]

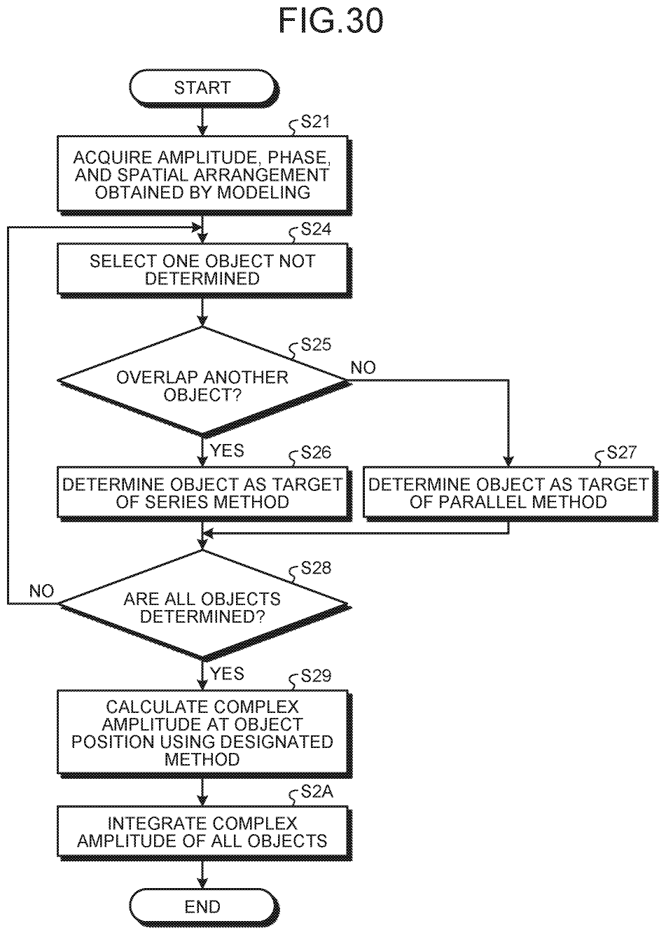

FIG. 30 is a diagram illustrating an example of the wavefront propagation calculation process of the information processing apparatus 20 according to the fifth embodiment. In the spatial arrangement control process, the same parts as those in the processing procedure illustrated in FIG. 30 will not be described in detail. The processing procedure illustrated in FIG. 30 is executed by the control unit 22 of the information processing apparatus 20.

The control unit 22 executes the wavefront propagation calculation process in Step S20 described above (Step S20). The wavefront propagation calculation process includes, for example, a process of calculating wavefront propagation based on the object beam data 21B.

For example, when the wavefront propagation calculation process illustrated in FIG. 30 is executed, the control unit 22 acquires the amplitude, phase, and spatial arrangement obtained by modeling (Step S21). Then, the control unit 22 selects one object 200 that has not been determined (Step S24). For example, the control unit 22 sequentially acquires the object 200 from the image data 21A. When the process in Step S24 is completed, the control unit 22 advances the process to Step S25.

The control unit 22 determines whether the object 200 overlaps another object 200 (Step S25). For example, based on the amplitude, phase, and spatial arrangement obtained by modeling, the control unit 22 determines whether or not the selected object 200 and another object 200 overlap each other when an overlapping ratio of display areas HT of the selected object 200 and the another object 200 is equal to or less than a determination threshold. When it is determined that the object 200 overlaps the another object 200 (Yes in Step S25), the control unit 22 advances the process to Step S26. The control unit 22 determines the object 200 as a target of the series method (Step S26). In other words, the control unit 22 determines to use, for this object 200, the series method as the optimization system using the iterative method. When the process in Step S26 is completed, the control unit 22 advances the process to Step S28 described later.

When it is determined that the object 200 does not overlap another object 200 (No in Step S25), the control unit 22 advances the process to Step S27. The control unit 22 determines the object 200 as a target of the parallel method (Step S27). In other words, the control unit 22 determines to use, for this object 200, the parallel method as the optimization method using the iterative method. When the process in Step S27 is completed, the control unit 22 advances the process to Step S28.

The control unit 22 determines whether all the objects 200 have been determined (Step S28). For example, when all the objects 200 obtained by modeling have been selected, the control unit 22 determines that all the objects 200 have been determined. When the control unit 22 determines that all the objects 200 have not yet been determined (No in Step S28), the control unit 22 returns the process to Step S24 described above and continues the processing procedure. When it is determined that all the objects 200 have been determined (Yes in Step S28), the control unit 22 advances the process to Step S29.

The control unit 22 calculates the complex amplitude at the display position using the designated method (Step S29). For example, the control unit 22 independently executes an iterative calculation loop for each of the plurality of layers with respect to the objects 200 for which the parallel method is designated, and generates the wavefront data 21C on the display surface H1. For example, the control unit 22 integrates all the layers with respect to the objects 200 for which the series method is designated, and performs the iterative calculation loop considering the complex amplitude distribution in all the layers to generate the wavefront data 21C on the display surface H1. In the case of the series method, any one of the first to fourth embodiments described above, or a combination thereof, can generate the wavefront data 21C on the display surface H1. When the process in Step S29 is completed, the control unit 22 advances the process to Step S2A.

The control unit 22 integrates the complex amplitudes of all objects 200 (Step S2A). For example, the control unit 22 integrates the independent wavefront data 21C in each layer and stores an integration result in the storage unit 21. When the process in Step S2A is completed, the control unit 22 ends the processing procedure illustrated in FIG. 30 and returns the process to the wavefront propagation calculation process in Step S20 illustrated in FIG. 9 described above. Thereafter, the control unit 22 executes the process from Step S30 to Step S50 illustrated in FIG. 9.

As described above, the information processing apparatus 20 according to the fifth embodiment determines the optimization system of the complex amplitude of the object 200 based on the overlapping ratio between the display area HT of the object 200 and the HT display area of another object 200, and calculates the complex amplitude on the display surface H1 of the object 200 by the determined optimization system. Accordingly, the information processing apparatus 20 can switch the method of calculating the wavefront data 21C depending on a degree of overlap of the display areas HT. As a result, the information processing apparatus 20 can reproduce the object beams L of the plurality of objects 200 with further higher image quality on the display medium 11. Furthermore, the information processing apparatus 20 can more reliably maintain the stereoscopic effect without making the depth of field of the plurality of objects 200 too deep.

Note that the information processing apparatus 20 according to the fifth embodiment may be applied to or combined with the information processing apparatus 20 of another embodiment or modification. For example, by executing the fifth embodiment in combination with any one of the first to fourth embodiments, the calculation can be performed by changing the spatial arrangement of the objects 200 and the size and shape of the display areas HT by the series method.

### Sixth Embodiment

Next, an example of an information processing apparatus 20 according to a sixth embodiment will be described. An information processing system 1 according to the sixth embodiment has the same configuration as the information processing system 1 according to the fifth embodiment.

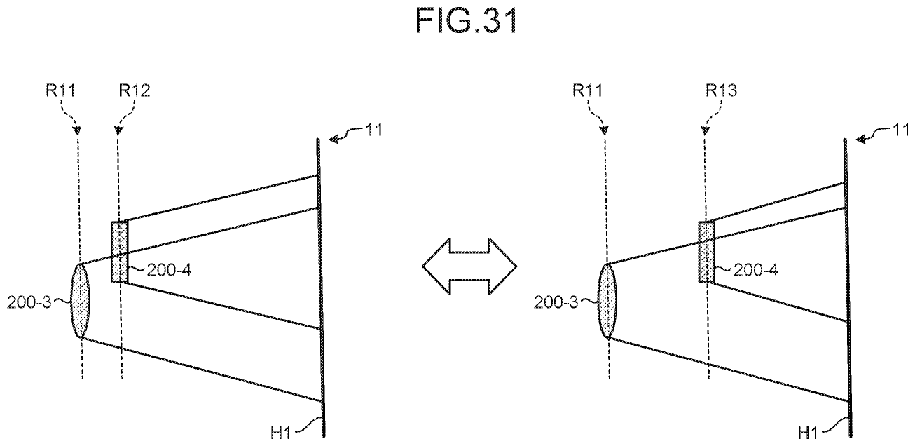

FIG. 31 is a diagram illustrating the information processing apparatus 20 according to the sixth embodiment. In the fifth embodiment, in the multilayer processing, when the positional relationship between three-dimensional objects 200 is close, an overlapping ratio of the display areas HT increases, or the spatial frequency necessary for changing brightness between the layers increases. In this case, in the fifth embodiment, a final image quality after iterative calculation is deteriorated or convergence is not successful. The information processing apparatus 20 according to the sixth embodiment provides a function of facilitating an optimization loop.

As illustrated in a left diagram of FIG. 31, when a distance between the layer R11 of the object 200-3 and the layer R12 of the object 200-4 is short, the information processing apparatus 20 applies in advance band limitation to an amplitude of object beam L of a reproduction target or increases a band of an initial phase. As illustrated in a right diagram of FIG. 31, when a distance between the layer R11 of the object 200-3 and a layer R13 of the object 200-4 is long, the information processing apparatus 20 does not apply in advance the band limitation to the amplitude of the object beam L of the reproduction target or decreases the band of the initial phase. The information processing apparatus 20 according to the sixth embodiment provides a function of facilitating a cycle of a minimization loop.

In an example of the left diagram of FIG. 31, when the distance between the layer R11 and the layer R12 is shorter than a threshold, the information processing apparatus 20 applies in advance the band limitation to the amplitude of the object beam L of the reproduction target or increases the band of the initial phase to bring the phase close to a random phase. In an example of the right diagram of FIG. 31, when the distance between the layer R11 and the layer R13 is longer than the threshold, the information processing apparatus 20 does not apply the band limitation to the amplitude of the object beam L of the reproduction target or decreases the band of the initial phase to bring the phase close to a fixed phase.

### [Wavefront Propagation Calculation Process]

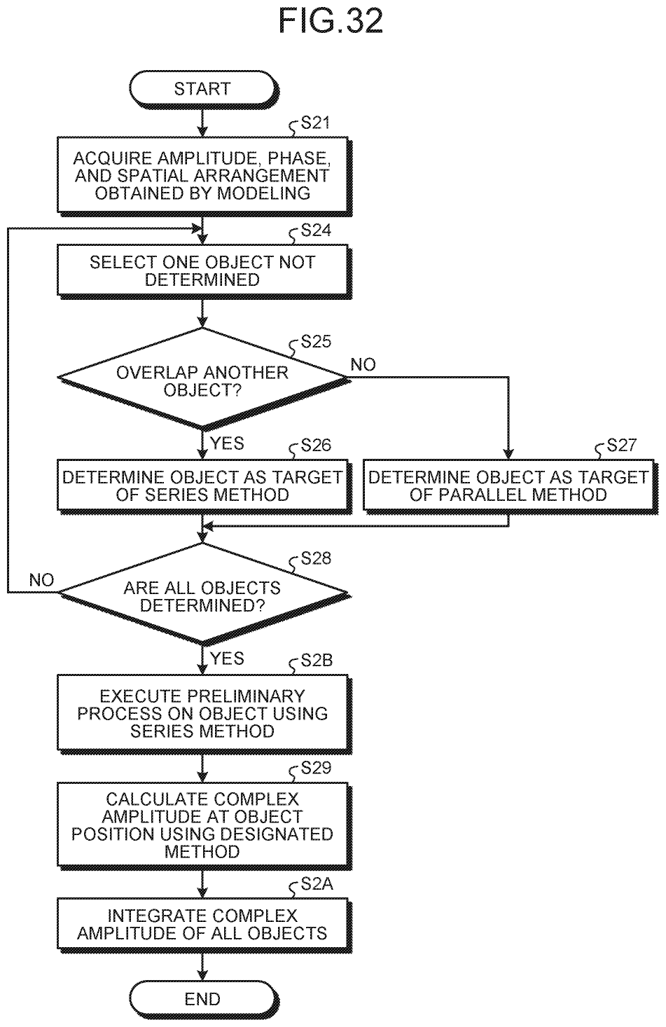

FIG. 32 is a diagram illustrating an example of the wavefront propagation calculation process of the information processing apparatus 20 according to the sixth embodiment. In the spatial arrangement control process, the same parts as those in the processing procedure illustrated in FIG. 30 will not be described in detail. The processing procedure illustrated in FIG. 32 is executed by the control unit 22 of the information processing apparatus 20.

The control unit 22 executes the wavefront propagation calculation process in Step S20 described above (Step S20). The wavefront propagation calculation process includes, for example, a process of calculating wavefront propagation based on the object beam data 21B.

For example, when the wavefront propagation calculation process illustrated in FIG. 32 is executed, the control unit 22 acquires the amplitude, phase, and spatial arrangement obtained by modeling (Step S21). Then, the control unit 22 selects one object 200 that has not been determined (Step S24). When the process in Step S24 is completed, the control unit 22 advances the process to Step S25.

The control unit 22 determines whether the object 200 overlaps another object 200 (Step S25). When it is determined that the object 200 overlaps the another object 200 (Yes in Step S25), the control unit 22 advances the process to Step S26. The control unit 22 determines the object 200 as a target of the series method (Step S26). When the process in Step S26 is completed, the control unit 22 advances the process to Step S28 described later.

When it is determined that the object 200 does not overlap another object 200 (No in Step S25), the control unit 22 advances the process to Step S27. The control unit 22 determines the object 200 as a target of the parallel method (Step S27). When the process in Step S27 is completed, the control unit 22 advances the process to Step S28.

The control unit 22 determines whether all the objects 200 have been determined (Step S28). When the control unit 22 determines that all the objects 200 have not yet been determined (No in Step S28), the control unit 22 returns the process to Step S24 described above and continues the processing procedure. When it is determined that all the objects 200 have been determined (Yes in Step S28), the control unit 22 advances the process to Step S22B.

The control unit 22 executes a preliminary process on the object 200 using the serial method (Step S2B). The preliminary process includes, for example, adjustment of the initial phase according to a distance to an adjacent object 200. In the preliminary process, for example, the amplitude may be adjusted according to the distance to the adjacent object 200.

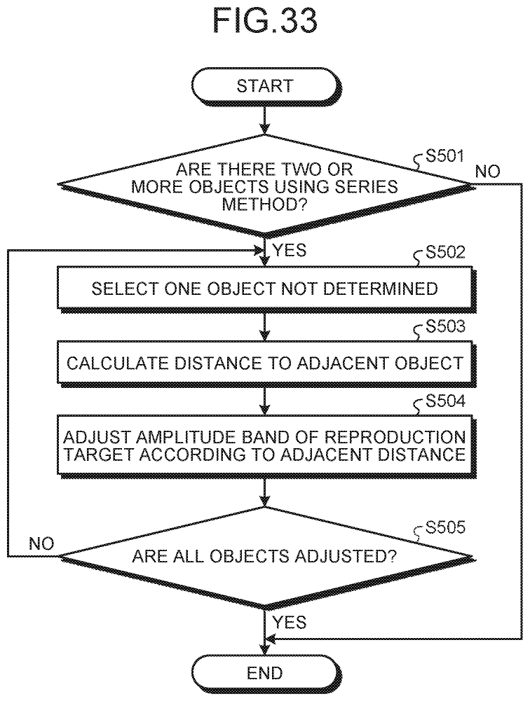

FIG. 33 is a flowchart illustrating an example of a processing procedure of the preliminary process in FIG. 32. When the preliminary process is executed in Step S2B, the control unit 22 determines whether or not there are two or more objects 200 using the series method (Step S501). When the number of objects 200 determined to be targets of the series method in Step S26 is two or more, the control unit 22 determines that there are two or more objects 200 applicable to the series method. The control unit 22 selects one object 200 that has not been determined (Step S502). For example, the control unit 22 selects one object 200 from the objects 200 applicable to the series method. When the process in Step S502 is completed, the control unit 22 advances the process to Step S503.

The control unit 22 calculates the distance to the adjacent object 200 (Step S503). For example, the control unit 22 calculates the distance based on the object position 200P of the adjacent object 200 and the object position 200P of the selected object 200. After storing a calculated adjacent distance in the storage unit 21 in association with the object 200, the control unit 22 advances the process to Step S504.

The control unit 22 adjusts an amplitude band of the target object according to the adjacent distance (Step S504). For example, when the adjacent distance is short, the control unit 22 applies in advance the band limitation to the amplitude of the object beam L of the reproduction target by the information processing apparatus 20. For example, when the adjacent distance is short, the control unit 22 applies in advance the band limitation to the amplitude of the object beam L of the reproduction target. When the process in Step S504 is completed, the control unit 22 advances the process to Step S505.

The control unit 22 determines whether all the objects 200 have been adjusted (Step S505). When the control unit 22 determines that all of the objects 200 have not yet been adjusted (No in Step S505), the control unit 22 returns the process to Step S502 described above, and continues the processing procedure. When it is determined that all the objects 200 have been adjusted (Yes in Step S505), the control unit 22 ends the preliminary process illustrated in FIG. 33 and returns the process to Step S2B illustrated in FIG. 32.

Returning to FIG. 32, when Step S2B is completed, the control unit 22 calculates the complex amplitude at the object position 200P by the designated method (Step S29). For example, when the parallel method is designated, the control unit 22 independently executes the iterative calculation loop for each of the plurality of layers and generates the wavefront data 21C on the display surface H1. For example, when the series method is designated, the control unit 22 independently executes the iterative calculation loop for each of the plurality of layers with respect to the adjusted objects 200, and generates the wavefront data 21C on the display surface H1. In the case of the series method, any one of the first to fourth embodiments described above, or a combination thereof, can generate the wavefront data 21C on the display surface H1. When the process in Step S29 is completed, the control unit 22 advances the process to Step S2A.

The control unit 22 integrates the complex amplitudes of all objects 200 (Step S2A). For example, the control unit 22 integrates the independent wavefront data 21C in each layer and stores an integration result in the storage unit 21. When the process in Step S2A is completed, the control unit 22 ends the processing procedure illustrated in FIG. 29 and returns the process to the wavefront propagation calculation process in Step S20 illustrated in FIG. 9 described above. Thereafter, the control unit 22 executes the process from Step S30 to Step S50 illustrated in FIG. 9.

As described above, when the plurality of display areas HT overlaps each other, the information processing apparatus 20 according to the sixth embodiment can change at least one of the amplitude and the phase of the object 200 so as to achieve the band of the object beam L for eliminating the overlap HK of the plurality of display areas HT based on the distance from the display positions of the objects whose display areas HT overlap in the display medium 11. Accordingly, the information processing apparatus 20 can suppress the plurality of object beams L from overlapping on the display surface H1 by controlling the amplitude of the object beam L and the band of the initial phase. As a result, the information processing apparatus 20 can reproduce the object beams L of the plurality of objects 200 with further higher image quality on the display medium 11. Furthermore, the information processing apparatus 20 can more reliably maintain the stereoscopic effect without making the depth of field of the plurality of objects 200 too deep.

Note that the information processing apparatus 20 according to the sixth embodiment may be applied to or combined with the information processing apparatus 20 of another embodiment or modification.

### [Hardware Configuration]

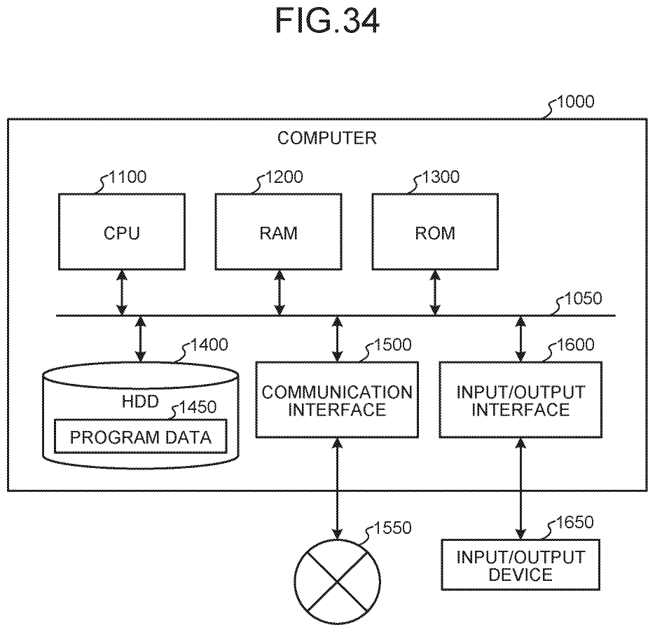

The information processing apparatus 20 according to the above-described embodiments may be implemented by a computer 1000, for example, having a configuration as illustrated in FIG. 34. Hereinafter, the information processing apparatus 20 according to the embodiments will be described as an example. FIG. 34 is a hardware configuration diagram illustrating an example of the computer 1000 that implements functions of the information processing apparatus 20. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates based on a program stored in the ROM 1300 or the HDD 1400, and controls each unit. For example, the CPU 1100 develops a program stored in the ROM 1300 or the HDD 1400 into the RAM 1200, and executes processes corresponding to various programs.

The ROM 1300 stores a boot program such as a basic input output system (BIOS) executed by the CPU 1100 when the computer 1000 is activated, a program dependent on hardware of the computer 1000, and the like.

The HDD 1400 is a computer-readable recording medium that non-transiently records a program executed by the CPU 1100, data used by the program, and the like. Specifically, the HDD 1400 is a recording medium that records the information processing program according to the present disclosure, which is an example of program data 1450.

The communication interface 1500 is an interface for the computer 1000 to connect to an external network 1550 (e.g., the Internet). For example, the CPU 1100 receives data from another apparatus or transmits data generated by the CPU 1100 to another apparatus via the communication interface 1500.

The input/output interface 1600 is an interface for connecting an input/output device 1650 and the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD), a magneto-optical recording medium such as a magneto-optical disk (MO), a tape medium, a magnetic recording medium, a semiconductor memory, or the like.

For example, when the computer 1000 functions as the information processing apparatus 20 according to the embodiments, the CPU 1100 of the computer 1000 executes a program loaded on the RAM 1200 to implement the functions of the object beam generation unit 23, the wavefront propagation calculation unit 24, and the interference fringe generation unit 25. The CPU 1100 implements functions of the detection unit 22A, the change unit 22B, the generation unit 22C, the determination unit 22D, the calculation unit 22E, and the like. In addition, the HDD 1400 stores a program according to the present disclosure and the data in the storage unit 21. Note that the CPU 1100 reads the program data 1450 from the HDD 1400 and executes the program data 1450. As another example, these programs may be acquired from another device via the external network 1550.

Although the preferred embodiment of the present disclosure has been described in detail with reference to the accompanying drawings, the technical scope of the present disclosure is not limited to these examples. It is obvious that a person having ordinary knowledge in the technical field of the present disclosure can conceive various changes or modifications within the scope of the technical idea described in the claims, and it is naturally understood that these also belong to the technical scope of the present disclosure.

Furthermore, the effects described in the present specification are merely illustrative or exemplary, and are not restrictive. In other words, the technology according to the present disclosure can exhibit other effects obvious to those skilled in the art from the description of the present specification in addition to or instead of the above effects.

Furthermore, it is also possible to create a program for causing hardware such as a CPU, a ROM, and a RAM built in a computer to exhibit a function equivalent to the configuration of the information processing apparatus 20, and provide a computer-readable recording medium in which the program is recorded.

Note that each step related to the process of the information processing apparatus 20 in the present specification is not necessarily processed in time series in the order described in the flowchart. For example, each step related to the process of the information processing apparatus 20 may be processed in an order different from the order described in the flowchart, or may be processed in parallel.

### (Effects)

The information processing apparatus 20 includes the detection unit 22A that detects the overlap HK of the plurality of display areas HT corresponding to the object beam L of each of the plurality of objects 200 on the display surface H1 of the display medium 11 that displays the hologram data 21D, and the change unit 22B that changes at least one of the amplitude and the phase of at least one object 200 among the plurality of objects 200 corresponding to the overlapping display areas HT when the plurality of display areas HT overlaps each other, so that the display areas HT are different from a case where the display areas HT overlap each other on the display surface H1.

Accordingly, when the display areas HT overlap each other on the display surface H1, the information processing apparatus 20 can change the spatial arrangement of the objects 200. As a result, the information processing apparatus 20 can reproduce the object beams L of the plurality of objects 200 with high image quality on the display medium 11. Furthermore, the information processing apparatus 20 can maintain a stereoscopic effect without excessively increasing the depth of field of the plurality of objects 200.

In the information processing apparatus 20, when the plurality of display areas HK overlaps each other, the change unit 22B changes at least one of the amplitude and the phase of the object 200 so as to achieve an arrangement that eliminates the overlap HK of the display area HT with another display area HT.

Accordingly, the information processing apparatus 20 can reliably prevent the plurality of object beams L from overlapping on the display surface H1. As a result, the information processing apparatus 20 can reproduce the object beams L of the plurality of objects 200 with further higher image quality on the display medium 11. Furthermore, the information processing apparatus 20 can more reliably maintain the stereoscopic effect without making the depth of field of the plurality of objects 200 too deep.

In the information processing apparatus 20, when the plurality of display areas HT overlaps each other, the change unit 22B changes at least one of the amplitude and the phase of the object 200 so that at least one of the size and the shape is changed to eliminate the overlap HK of the plurality of display areas HT.

Accordingly, the information processing apparatus 20 can reliably prevent the plurality of object beams L from overlapping on the display surface H1. As a result, the information processing apparatus 20 can reproduce the object beams L of the plurality of objects 200 with further higher image quality on the display medium 11. Furthermore, the information processing apparatus 20 can more reliably maintain the stereoscopic effect without making the depth of field of the plurality of objects 200 too deep.

In the information processing apparatus 20, when the plurality of display areas HT overlaps each other, the change unit 22B changes at least one of the amplitude and the phase of the object 200 so as to achieve the band of the object beam L that eliminates the overlap HK of the plurality of display areas HT.

Accordingly, since the information processing apparatus 20 can limit the band of the initial phase, it is possible to more reliably suppress the plurality of object beams L from overlapping on the display surface H1. As a result, the information processing apparatus 20 can reproduce the object beams L of the plurality of objects 200 with further higher image quality on the display medium 11. Furthermore, the information processing apparatus 20 can more reliably maintain the stereoscopic effect without making the depth of field of the plurality of objects 200 too deep.

In the information processing apparatus 20, the priority is set to the plurality of objects 200. When the plurality of display areas HT overlaps each other, the change unit 22B changes at least one of the amplitude and the phase of the object so as to achieve an arrangement that eliminates the overlap HK of the display area HT with another display area HT. based on the priority of the object 200 corresponding to the display area HT.

Accordingly, the information processing apparatus 20 can suppress the plurality of object beams L from overlapping on the display surface H1 in consideration of the priority of the plurality of objects 200. As a result, the information processing apparatus 20 can reproduce the object beams L of the plurality of objects 200 with further higher image quality on the display medium 11. Furthermore, the information processing apparatus 20 can more reliably maintain the stereoscopic effect without making the depth of field of the plurality of objects 200 too deep.

In the information processing apparatus 20, when the plurality of display areas HK overlap, the change unit 22B preferentially changes at least one of the amplitude and the phase of the object 200 having a low priority among the objects 200 corresponding to the overlapping display areas HT based on the priority of the object 200 corresponding to the display area HK.

Accordingly, the information processing apparatus 20 can prevent the display position of the object 200 with high priority from being changed by changing the object 200 with low priority. As a result, the information processing apparatus 20 can ensure the visibility of display using the display medium 11 since the object 200 with high priority is not hindered by the object 200 with low priority.

The information processing apparatus 20 further includes the determination unit 22D that determines the optimization system of the complex amplitude of the object 200 based on the overlapping ratio between the display area HT of the object 200 and the display area HT of another object 200, and the calculation unit 22E that calculates the complex amplitude on the display surface HT of the object 200 by the optimization system determined.

As a result, the information processing apparatus 20 can efficiently calculate the complex amplitude by switching the method of calculating the wavefront data 21C based on the overlapping ratio of the display areas HT. As a result, the information processing apparatus 20 can reproduce the object beams L of the plurality of objects 200 with further higher image quality on the display medium 11. Furthermore, the information processing apparatus 20 can more reliably maintain the stereoscopic effect without making the depth of field of the plurality of objects 200 too deep.

In the information processing apparatus 20, when the plurality of display areas HT overlaps each other, the change unit 22B changes at least one of the amplitude and the phase of the object 200 so as to obtain the band of the object beam L for eliminating the overlap HK of the plurality of display areas HT based on the distance from the object position 200P of the object 200 where the display areas HT overlap to the display medium 11.

Accordingly, the information processing apparatus 20 can suppress the plurality of object beams L from overlapping on the display surface H1 by controlling the amplitude of the object beam L and the band of the initial phase. As a result, the information processing apparatus 20 can reproduce the object beams L of the plurality of objects 200 with further higher image quality on the display medium 11. Furthermore, the information processing apparatus 20 can more reliably maintain the stereoscopic effect without making the depth of field of the plurality of objects 200 too deep.

The information processing apparatus 20 further includes the generation unit 22C that generates the hologram data 21D having at least one of the changed amplitude and phase of the object 200.

Accordingly, the information processing apparatus 20 can include the object 200 changed according to the overlap HK of the display area HT on the display surface H1 in the hologram data 21D, and thus, can display the changed hologram data 21D on the display medium 11. As a result, the information processing apparatus 20 can reproduce the object beams L of the plurality of objects 200 with high image quality on the display medium 11. Furthermore, the information processing apparatus 20 can maintain a stereoscopic effect without excessively increasing the depth of field of the plurality of objects 200.

The information processing apparatus 20 includes the object beam generation unit 23 that generates the object beam data 21B from the image data 21A, the wavefront propagation calculation unit 24 that calculates the wavefront propagation based on the object beam data 21B, and the interference fringe generation unit 25 that generates the hologram data 21D indicating the interference fringe based on a calculation result of the wavefront propagation. The change unit 22B is included in the object beam generation unit 23 or the wavefront propagation calculation unit 24, and the generation unit 22C is included in the interference fringe generation unit 25.

As a result, when the display areas HT of the plurality of objects 200 obtained from the image data 21A overlap each other, the information processing apparatus 20 can provide the hologram data 21D in which the arrangement of the plurality of objects 200 is changed to the display medium 11. As a result, the information processing apparatus 20 can reproduce the object beam L including the plurality of objects 200 obtained from the image data 21A with high image quality on the display medium 11.

The information processing method implemented by the computer includes detecting the overlap HK of the plurality of display areas HT corresponding to the object beam L of each of the plurality of objects 200 on the display surface H1 of the display medium 11 that displays the hologram data 21D, and changing at least one of the amplitude and the phase of at least one object 200 among the plurality of objects 200 corresponding to the overlapping display areas HT when the plurality of display areas HT overlaps each other, so that the display areas HT are different from a case where the display areas HT overlap each other on the display surface H1.

Accordingly, in the information processing method, when the display areas HT overlap each other on the display surface H1, the computer can change the spatial arrangement of the objects 200. As a result, the information processing method can reproduce the object beam L including the plurality of objects 200 on the display medium 11 with high image quality. Furthermore, the information processing method can maintain the stereoscopic effect without excessively increasing the depth of field of the plurality of objects 200.

The recording medium is a computer-readable recording medium recording a program for causing a computer to implement detecting the overlap HK of the plurality of display areas HT corresponding to the object beam L of each of the plurality of objects 200 on the display surface H1 of the display medium 11 that displays the hologram data 21D, and changing at least one of the amplitude and the phase of at least one object 200 among the plurality of objects 200 corresponding to the overlapping display area HT when the plurality of display areas HT overlaps each other, so that the display areas HT are different from a case where the display areas HT overlap each other on the display surface H1.

Accordingly, the recording medium can cause the computer to change the spatial arrangement of the objects 200 when the display areas HT overlap each other on the display surface H1 by causing the computer to execute the recorded program. As a result, the recording medium can reproduce the object beam L including the plurality of objects 200 on the display medium 11 with high image quality. Furthermore, the recording medium can maintain the stereoscopic effect without excessively increasing the depth of field of the plurality of objects 200.

Note that the following configurations also belong to the technical scope of the present disclosure.
(1)
   An information processing apparatus comprising:
   a detection unit configured to detect an overlap of a plurality of display areas each corresponding to an object beam of an object on a display surface of a display medium that displays hologram data; and
   a change unit configured to change at least one of an amplitude and a phase of at least one of a plurality of the objects corresponding to the plurality of display areas overlapped when the plurality of display areas overlap each other, one of the amplitude and the phase being changed so as to achieve the display areas different from a case where the display areas overlap each other on the display surface.
(2)
   The information processing apparatus according to (1), wherein
   when the plurality of display areas overlap each other, the change unit changes at least one of the amplitude and the phase of the object so as to achieve an arrangement that eliminates the overlap of one of the plurality of display areas with another one of the plurality of display areas.
(3)
   The information processing apparatus according to (1) or (2), wherein
   when the plurality of display areas overlap each other, the change unit changes at least one of the amplitude and the phase of the object so as to achieve at least one of a size and a shape that eliminates the overlap of the plurality of display areas.
(4)
   The information processing apparatus according to (1) or (2), wherein
   when the plurality of display areas overlap, the change unit changes at least one of the amplitude and the phase of the object so as to achieve a band of the object beam that eliminates the overlap of the plurality of display areas.
(5)
   The information processing apparatus according to any one of (1) to (4), wherein
   the plurality of objects is given priority, and
   when the plurality of display areas overlap, the change unit changes at least one of the amplitude and the phase of the object so as to achieve an arrangement that eliminates the overlap of one of the plurality of display areas overlapped with another one of the plurality of display areas according to the priority of the object corresponding to the display area.
(6)
   The information processing apparatus according to (5), wherein
   when the plurality of display areas overlap, the change unit preferentially changes at least one of the amplitude and the phase of the object with low priority among the objects corresponding to the display areas overlapped according to the priority given to each of the objects corresponding to the display areas.
(7)
   The information processing apparatus according to any one of (1) to (6), further comprising:
   a determination unit configured to determine an optimization system of a complex amplitude of the object based on an overlapping ratio between the display area of one object of the plurality of objects and the display area of another one object of the plurality of objects; and
   a calculation unit configured to calculate the complex amplitude on the display surface of the one object using the optimization system determined.
(8)
   The information processing apparatus according to any one of (1) to (7), wherein
   when the plurality of display areas overlap, the change unit changes at least one of the amplitude and the phase of the object so as to achieve a band of the object beam that eliminates the overlap of the plurality of display areas according to a distance to the display medium from an object position of the object having the display area overlapped.
(9)
   The information processing apparatus according to any one of (1) to (8), further comprising:
   a generation unit configured to generate the hologram data of the object having at least one of the amplitude and the phase that has been changed.
(10)
   The information processing apparatus according to (9), further comprising:
   an object beam generation unit configured to generate object beam data from image data;
   a wavefront propagation calculation unit configured to calculate wavefront propagation based on the object beam data; and
   an interference fringe generation unit configured to generate the hologram data indicating an interference fringe based on a calculation result of the wavefront propagation, wherein
   the change unit is included in the object beam generation unit or the wavefront propagation calculation unit, and
   the generation unit is included in the interference fringe generation unit.
(11)
   An information processing method causing a computer to implement:
   detecting an overlap of a plurality of display areas each corresponding to an object beam of an object on a display surface of a display medium that displays hologram data; and
   changing at least one of an amplitude and a phase of at least one of a plurality of the objects corresponding to the plurality of display areas overlapped when the plurality of display areas overlap each other, one of the amplitude and the phase being changed so as to achieve the display areas different from a case where the display areas overlap each other on the display surface.
(12)
   A computer-readable recording medium storing an information processing program causing a computer to implement:
   detecting an overlap of a plurality of display areas each corresponding to an object beam of an object on a display surface of a display medium that displays hologram data; and
   changing at least one of an amplitude and a phase of at least one of a plurality of the objects corresponding to the plurality of display areas overlapped when the plurality of display areas overlap each other, one of the amplitude and the phase being changed so as to achieve the display areas different from a case where the display areas overlap each other on the display surface.
(13)
   An information processing program causing a computer to implement:
   detecting an overlap of a plurality of display areas each corresponding to an object beam of each of a plurality of objects on a display surface of a display medium that displays hologram data,
   changing at least one of an amplitude and a phase of at least one of the plurality of objects corresponding to an overlapping display area on the display surface, so that the display areas are different from a case where the display areas overlap each other on the display surface.
(14)
   An information processing system comprising:
   a display medium; and
   an information processing apparatus configured to display a hologram based on hologram data on the display medium, wherein
   the information processing apparatus includes:
   a detection unit that detects an overlap of a plurality of display areas each corresponding to an object beam of each of a plurality of objects on a display surface of the display medium, and
   a change unit that changes at least one of an amplitude and a phase of at least one of the plurality of objects corresponding to an overlapping display area on the display surface, so that the display areas are different from a case where the display areas overlap each other on the display surface.

### REFERENCE SIGNS LIST

1 INFORMATION PROCESSING SYSTEM
10 HOLOGRAM DISPLAY UNIT
11 DISPLAY MEDIUM
12 LIGHT SOURCE
20 INFORMATION PROCESSING APPARATUS
21 STORAGE UNIT
21A IMAGE DATA
21B OBJECT BEAM DATA
21C WAVEFRONT DATA
21D HOLOGRAM DATA
22 CONTROL UNIT
22A DETECTION UNIT
22B CHANGE UNIT
22C GENERATION UNIT
22D DETERMINATION UNIT
22E CALCULATION UNIT
23 OBJECT BEAM GENERATION UNIT
24 WAVEFRONT PROPAGATION CALCULATION UNIT
25 INTERFERENCE FRINGE GENERATION UNIT
200 OBJECT
200P OBJECT POSITION
800 FOREGROUND
H HOLOGRAM
H1 DISPLAY SURFACE
HT DISPLAY AREA
HK OVERLAP

1. An information processing apparatus comprising:
a detection unit configured to detect an overlap of a plurality of display areas each corresponding to an object beam of an object on a display surface of a display medium that displays hologram data; and
a change unit configured to change at least one of an amplitude and a phase of at least one of a plurality of the objects corresponding to the plurality of display areas overlapped when the plurality of display areas overlap each other, one of the amplitude and the phase being changed so as to achieve the display areas different from a case where the display areas overlap each other on the display surface.

2. The information processing apparatus according to claim 1, wherein
when the plurality of display areas overlap each other, the change unit changes at least one of the amplitude and the phase of the object so as to achieve an arrangement that eliminates the overlap of one of the plurality of display areas with another one of the plurality of display areas.

3. The information processing apparatus according to claim 1, wherein
when the plurality of display areas overlap each other, the change unit changes at least one of the amplitude and the phase of the object so as to achieve at least one of a size and a shape that eliminates the overlap of the plurality of display areas.

4. The information processing apparatus according to claim 1, wherein
when the plurality of display areas overlap, the change unit changes at least one of the amplitude and the phase of the object so as to achieve a band of the object beam that eliminates the overlap of the plurality of display areas.

5. The information processing apparatus according to claim 1, wherein
the plurality of objects is given priority, and
when the plurality of display areas overlap, the change unit changes at least one of the amplitude and the phase of the object so as to achieve an arrangement that eliminates the overlap of one of the plurality of display areas overlapped with another one of the plurality of display areas according to the priority of the object corresponding to the display area.

6. The information processing apparatus according to claim 5, wherein
when the plurality of display areas overlap, the change unit preferentially changes at least one of the amplitude and the phase of the object with low priority among the objects corresponding to the display areas overlapped according to the priority given to each of the objects corresponding to the display areas.

7. The information processing apparatus according to claim 1, further comprising:
a determination unit configured to determine an optimization system of a complex amplitude of the object based on an overlapping ratio between the display area of one object of the plurality of objects and the display area of another one object of the plurality of objects; and
a calculation unit configured to calculate the complex amplitude on the display surface of the one object using the optimization system determined.

8. The information processing apparatus according to claim 1, wherein
when the plurality of display areas overlap, the change unit changes at least one of the amplitude and the phase of the object so as to achieve a band of the object beam that eliminates the overlap of the plurality of display areas according to a distance to the display medium from an object position of the object having the display area overlapped.

9. The information processing apparatus according to claim 1, further comprising:
a generation unit configured to generate the hologram data of the object having at least one of the amplitude and the phase that has been changed.

10. The information processing apparatus according to claim 9, further comprising:
an object beam generation unit configured to generate object beam data from image data;
a wavefront propagation calculation unit configured to calculate wavefront propagation based on the object beam data; and
an interference fringe generation unit configured to generate the hologram data indicating an interference fringe based on a calculation result of the wavefront propagation, wherein
the change unit is included in the object beam generation unit or the wavefront propagation calculation unit, and
the generation unit is included in the interference fringe generation unit.

11. An information processing method causing a computer to implement:
detecting an overlap of a plurality of display areas each corresponding to an object beam of an object on a display surface of a display medium that displays hologram data; and
changing at least one of an amplitude and a phase of at least one of a plurality of the objects corresponding to the plurality of display areas overlapped when the plurality of display areas overlap each other, one of the amplitude and the phase being changed so as to achieve the display areas different from a case where the display areas overlap each other on the display surface.

12. A computer-readable recording medium storing an information processing program causing a computer to implement:
detecting an overlap of a plurality of display areas each corresponding to an object beam of an object on a display surface of a display medium that displays hologram data; and
changing at least one of an amplitude and a phase of at least one of a plurality of the objects corresponding to the plurality of display areas overlapped when the plurality of display areas overlap each other, one of the amplitude and the phase being changed so as to achieve the display areas different from a case where the display areas overlap each other on the display surface.
